(19) United States
(12) Patent Application Publication
(10) Pub. No.: US 2012/0317038 A1
(43) Pub. Date: Dec. 13, 2012

(54) SYSTEM AND METHODS FOR OPTIMIZING CUSTOMER COMMUNICATIONS

(75) Inventors: William C. Erbey, Christiansted, VI (US); Seth E. Carter, Winston-Salem, NC (US); Kevin J. Wilcox, Luxembourg (LU)

(73) Assignee: ALTISOURCE SOLUTIONS S.A R.L., Luxembourg (LU)

(21) Appl. No.: 13/443,618

(22) Filed: Apr. 10, 2012

Related U.S. Application Data
(60) Provisional application No. 61/474,642, filed on Apr. 12, 2011.

(51) Int. Cl. G06Q 10/00

(52) U.S. Cl. 705/304

(57) ABSTRACT

A customer communication system having a scripting system coupled to a customer interface and at least one business system. The scripting system has at least one processor and at least one memory. The processor is configured to communicate with the customer interface and communicate with the at least one business system in real-time using a data format containing a unique identifier and a token value associated with a data value. The processor is also configured to provide a scripted conversation that is delivered to a customer, where the scripted conversation is predetermined based on one of information contained in a customer account, information provided by the customer and analytics and changes in real-time based on psychological factors of the customer that are detected during the customer communication.

### CLAIM OF PRIORITY

This application claims priority to U.S. Provisional Application Ser. No. 61/474,642 entitled “System and Methods for Optimizing Customer Communications,” filed Apr. 12, 2011. The entire disclosure of which is incorporated by reference herein.

### FIELD OF THE INVENTION

The present invention relates generally to systems and methods of optimizing customer communications. More particularly, the present invention relates to expert systems and methods of influencing customer behavior with regard to transactions.

### BACKGROUND OF THE INVENTION

Scripting is used in call centers, customer support centers, sales centers and technical support centers to improve customer service, telesales, and interaction with customers by telemarketing representatives and transaction coordination representatives. Scripts, as used herein, are interactive tools that guide a user, such as a telemarketer, sales person, or technical support technician through a telephone call with a customer. Scripts may be implemented through web pages, mobile device applications and computer software to provide an interactive experience to the customer. Scripts are characterized by branching from a question to particular subsequent questions, or to an associated database based on the customer's answer to a previous question, thereby automatically guiding the user-customer dialog while enforcing workflow and business processes. Scripts are used in a variety of different scenarios from sales to service in the financial, telecommunications, insurance, and retailing industries, among others. Scripts can be used to gather and/or disseminate information, create new customer records, take orders, etc. In prior art systems, scripting systems are designed to work with one or more business systems and are integrated directly into that business system. Thus, these integrated scripting systems are not easily reconfigurable without reconfiguring the entire business system in which the scripting system is integrated.

A clear need exists for a scripting system that is (1) self contained and not dependent upon any one business system, (2) easily reconfigurable without having to change programming code and recompile the software, (3) that interacts with one or more disparate business systems and (4) that can read data from one or more business systems and write data to one or more disparate business systems. For example, a need exists that allows scripts to be changed in real-time based on customer behavior, mood and responses so as to optimize the ability of the call center agent, customer service agent, telesales and telemarketer professionals to influence customer responses to achieve the most desirable outcome. As another example, scripts generally require a certain amount of customization, configuration and change based on the user's business or business process, to optimize customer interaction and results and to accommodate changes in metadata and metastructure of the business system. In prior art systems, script customization, configuration, reconfiguration, and optimization has required a substantial amount of code rewriting and revision, or a substantial amount of software overhead to support a very limited amount of mainly cosmetic customization features that integrate the scripting software into the business system. Thus, a need exists for a scripting method and system that facilitates end-user customization, configuration, reconfiguration and optimization without code rewriting to expedite placing improved scripting into production.

The present invention recognizes and addresses the foregoing disadvantages, and others, of prior art constructions and methods. Other objects, features and aspects of the present invention are provided by various combinations and sub-combinations of the disclosed elements, as well as methods of utilizing same, which are discussed in greater detail below.

A full and enabling disclosure of the present invention, including the best mode thereof, to one of ordinary skill in the art, is set forth more particularly in the remainder of the specification, including reference to the accompanying drawings. Repeat use of reference characters in the present specification and drawings is intended to represent same or analogous features or elements of the invention according to the disclosure.

### SUMMARY OF THE INVENTION

The present invention recognizes and addresses disadvantages of prior art constructions and methods, and in one embodiment of the present invention a customer communication system comprises a customer interface, at least one business system and a scripting system operatively coupled to the customer interface and the at least one business system. The scripting system comprises at least one processor and at least one memory wherein the at least one processor is configured to (1) communicate with said customer interface, (2) communicate with said at least one business system in real-time using a data format containing a unique identifier and a token value that can be associated with a data value, and (3) provide a scripted conversation to be delivered to a customer, where the scripted conversation is predetermined based on one of information contained in a customer account, information provided by the customer and analytics, and the predetermined scripted conversation changes in real-time based on psychological factors of the customer, detected during the customer communication.

In some embodiments, the customer's detected psychological factors are automatically detected and the predetermined scripted conversation is automatically changed based on the customer's detected psychological factors. In other embodiments, a user of the customer communication system detects the psychological factors of a customer and selects an option corresponding to the customer's psychological factors to cause a real-time change in the predetermined scripted conversation. In these embodiments, the psychological factors are based on the customer's emotional state.

In other embodiments, the predetermined scripted conversation is written based on behavioral sciences-based principles. In these embodiments, the predetermined scripted conversation is changed to reflect behavioral sciences-based principles that address the detected customer psychological factors. In still other embodiments, the behavioral sciences-based principles comprise at least one of an authority principle, a visceral heuristic, a liking principle, a social proof, an availability heuristic, an in-group bias, a scarcity principle, a default heuristic, an anchor-and-adjustment heuristic, a momentum/trajectory bias, a peak-end effect, a simulation heuristic description, a commitment principle, a reciprocity principle, a consistency principle, an endowment effect, a that's-not-all principle and a debiasing of sunk-cost heuristic.

In another embodiment of the present invention, a scripting system comprises at least one processor and at least one memory. In this embodiment, the scripting system is configured to communicate with a plurality of disparate business system databases by making a read request that includes a header having a unique identifier and a token, to which at least one of the plurality of disparate business systems respond by returning a value associated with the token, the at least one processor is configured to facilitate a predetermined scripted conversation with a customer based on information contained in the at least one of the plurality of business systems, and change the predetermined scripted conversation in real-time throughout the customer communication based on information received from the customer to change at least one of the desired outcomes, the method in which to achieve the desired outcome and behavioral sciences-based principles that affect the wording of the script that optimize achievement of the desired outcome.

In some embodiments, information received from the customer is written back, via the at least one processor, to at least one of the plurality of disparate business systems. In other embodiments, the processor is configured to change the predetermined scripted conversation in real-time based on psychological factors of the customer detected during the customer communication. In these embodiments, the customer's psychological factors are automatically detected by at least one of the customer's speech pattern, voice tone, voice pitch level, voice tempo, inflection and keywords. In other of these embodiments, the customer's psychological factors are automatically detected by at least one of the customer's speech pattern, voice tone, voice pitch level, voice tempo, inflection and keywords and the processor is configured to notify a user of the scripting system of the customer's likely psychological factors so that the user may manually select an option that automatically changes the predetermined scripted conversation.

In yet other embodiments, the predetermined scripted conversation is written based on behavioral sciences-based principles. In these embodiments, the behavioral sciences-based principles comprise at least one of an authority principle, a visceral heuristic, a liking principle, a social proof, an availability heuristic, an in-group bias, a scarcity principle, a default heuristic, an anchor-and-adjustment heuristic, a momentum/trajectory bias, a peak-end effect, a simulation heuristic description, a commitment principle, a reciprocity principle, a consistency principle, an endowment effect, a that's-not-all principle and a debiasing of sunk-cost heuristic.

In yet another embodiment of the present invention, the processor is further configured to allow an administrator to reconfigure the system to provide new and modified functionality without having to recode and recompile the system. In still other embodiments, the read request uses extensible markup language.

In another embodiment of the present invention a scripting system comprises at least one processor and at least one memory wherein the scripting system is configured to communicate with at least one disparate business system in real-time, the at least one processor is configured to receive a desired outcome from the at least one disparate business system, facilitate a predetermined scripted conversation with a customer to achieve the desired outcome, receive information from the customer so at least one of the desired outcomes and the method in which the desired outcome is achieved is changed in real-time, change the predetermined scripted conversation in real-time to reflect the change in the at least one of desired outcomes and the method in which the desired outcome is achieved, and behavioral sciences-based principles that affect the wording of the script to optimize achievement of the desired outcome.

In another embodiment, the at least one business system receives the received customer information and makes the decision to change the at least one of the desired outcomes and the method in which the desired outcome is achieved. In still another embodiment, the method in which the desired outcome is achieved comprises at least one of a price, a purchase term, a product feature and a service feature. In yet other embodiments, the change of the at least one of the desired outcome and the method in which the desired outcome is achieved is made by the scripting system. In still other embodiments, the changes to the script based on behavioral sciences-based principles are changed in real-time based on a perceived psychological state or trait of the customer detected during the customer communication. Moreover, in still other embodiments, the perceived psychological state or trait of the customer is either detected automatically by the scripting system or detected manually by a user of the scripting system.

Various combinations and sub-combinations of the disclosed elements, as well as methods of utilizing same, which are discussed in detail below, provide other objects, features and aspects of the present invention.

The accompanying drawings, which are incorporated in and constitute a part of this specification, illustrate one or more embodiments of the present invention.

### BRIEF DESCRIPTION OF THE FIGURES

A full and enabling disclosure of the present invention, including the best mode thereof directed to one of ordinary skill in the art, is set forth in the specification, which makes reference to the appended drawings, in which:

FIG. 1 is an exemplary system of various hardware components in accordance with an embodiment of the present invention;

FIG. 2 is a computer system capable of carrying out the functionality of the present invention;

FIG. 3 is a system flow diagram of an embodiment of the present invention;

FIGS. 4A and 4C are script interface windows for use with the scripting system of FIG. 3, in accordance with an embodiment of the present invention;

FIG. 4B is a script editor interface for use with the scripting system of FIG. 3, in accordance with an embodiment of the present invention;

FIGS. 5A-5K are user interface screens for use with the business parent system of FIG. 3, in accordance with an embodiment of the present invention;

FIGS. 6A-6B are activity user interfaces for use with the scripting system of FIG. 3, in accordance with an embodiment of the present invention;

FIG. 7 is a call trail interface for use with the scripting system of FIG. 3, in accordance with an embodiment of the present invention;

FIG. 8 is a scratch pad user interface for use with the scripting system of FIG. 3, in accordance with an embodiment of the present invention;

FIG. 9 is a script editor interface for use with FIGS. 4A - 4C, in accordance with an embodiment of the present invention;

FIG. 10 is a catalog editor module for use with the script editor interface of FIG. 9, in accordance with an embodiment of the present invention;

FIGS. 11A-11F are detailed script tabs for use in the script tree presentation of FIG. 10, in accordance with an embodiment of the present invention;

FIGS. 12A-12C are script testing windows for use in the catalog editor module of FIG.

10, in accordance with an embodiment of the present invention;

FIGS. 13A-13D are detailed menus for use in the catalog editor module of FIG. 10, in accordance with an embodiment of the present invention;

FIG. 14 is an import menu for use in the catalog editor module of FIG. 10, in accordance with an embodiment of the present invention;

FIG. 15 is a compare menu for use with the catalog editor module of FIG. 10, in accordance with an embodiment of the present invention;

FIG. 16 is a history menu for use with the catalog editor module of FIG. 10, in accordance with an embodiment of the present invention;

FIG. 17 is a token menu for use with the catalog editor module of FIG. 10, in accordance with an embodiment of the present invention;

FIG. 18 is a validate script menu for use with the detailed menus FIGS. 13A-13D, in accordance with an embodiment of the present invention;

FIG. 19 is a script info window for use with the detailed menus FIGS. 13A-13D, in accordance with an embodiment of the present invention;

FIG. 20 is a script history menu option for use with FIGS. 13A-13D, in accordance with an embodiment of the present invention;

FIG. 21 is a script editor module for use with the scripting system of FIG. 3, in accordance with an embodiment of the present invention;

FIG. 22 is a create script window for use with the scripting system of FIG. 3, in accordance with an embodiment of the present invention;

FIG. 23 is an option window for use with the create script window of FIG. 22, in accordance with embodiment of the present invention;

FIG. 24 is available speak indicator menus for use in the script editor module of FIG. 21, in accordance with an embodiment of the present invention;

FIG. 25 is an add speech text editing window for use with the script editor module of FIG. 21, in accordance with an embodiment of the present invention;

FIG. 26 is a create/edit window for use with the add speech text window of FIG. 25, in accordance with an embodiment of the present invention;

FIG. 27 is a token selection window for use with the add speech text window of FIG. 25, in accordance with an embodiment of the present invention;

FIG. 28 is an add options window for use with the script editor module menu in FIG. 24, in accordance with an embodiment of the present invention;

FIG. 29 is an add/edit option screen for use with the add options window of FIG. 28, in accordance with an embodiment of the present invention;

FIG. 30 is an add/edit action window for use with the add/edit option screen of FIG. 29, in accordance with an embodiment of the present invention;

FIG. 31 is an administration utility tab for use with the script editor interface of FIG. 4B, in accordance with an embodiment of the present invention;

FIG. 32 is an organization screen for use with the administration utility tab of FIG. 31, in accordance with an embodiment of the present invention;

FIG. 33 is a modify organization screen for use with the organization screen of FIG. 32, in accordance with an embodiment of the present invention;

FIG. 34 is an organization detail screen for use with FIG. 33, in accordance with an embodiment of the present invention;

FIG. 35 is a portfolio screen for use with administration utility tab of FIG. 31, in accordance with an embodiment of the present invention;

FIG. 36 is a register new portfolio screen for use with the portfolio screen of FIG. 35, in accordance with an embodiment of the present invention;

FIG. 37 is a portfolio listing screen for use with the portfolio screen of FIG. 35, in accordance with an embodiment of the present invention;

FIG. 38 is a portfolio details window for use with the portfolio listing screen of FIG. 37, in accordance with an embodiment of the present invention;

FIG. 39 is a portfolio delete listing for use with the portfolio screen of FIG. 35, in accordance with an embodiment of the present invention;

FIG. 40 is a portfolio delete details window for use with the portfolio delete listing of FIG. 39, in accordance with an embodiment of the present invention;

FIG. 41 is an external portfolio mapping window for use with the portfolio screen of FIG. 35, in accordance with an embodiment of the present invention;

FIG. 42 is a token master screen for use with the administration utility tab of FIG. 31, in accordance with an embodiment of the present invention;

FIG. 43 is a token reference screen for use with the token master screen of FIG. 42, in accordance with an embodiment of the present invention;

FIG. 44 is a widget editor screen for use with the administration utility tab of FIG. 31, in accordance with an embodiment of the present invention;

FIG. 45 is a widget definition and preview screen for use with the widget editor screen of FIG. 44, in accordance with an embodiment of the present invention;

FIG. 46 is a function editor screen for use with the administration utility tab of FIG. 31, in accordance with an embodiment of the present invention;

FIG. 47 is a wizard screen for use with an embodiment of the present invention;

FIG. 48 is an agent window for use with the administration utility tab of FIG. 31, in accordance with an embodiment of the present invention;

FIG. 49 is a user group window for use with the administration utility tab of FIG. 31, in accordance with an embodiment of the present invention;

FIG. 50 is a script search window for use with the administration utility tab of FIG. 31, in accordance with an embodiment of the present invention;

FIG. 51 is a business system integration interface for use with the administration utility tab of FIG. 31, in accordance with an embodiment of the present invention;

FIG. 52 is a system parameters user interface for use with the administration utility tab of FIG. 31, in accordance with an embodiment of the present invention;

FIG. 53 is an add system parameter screen for use with the system parameters user interface of FIG. 52, in accordance with an embodiment of the present invention;

FIG. 54 is an update system parameters screen for use with the system parameters user interface of an embodiment of the present invention;

FIG. 55 is a graphical representation of psychological factors that influence behavior and likelihood of desired outcome, in accordance with an embodiment of the present invention; and

FIGS. 56A-56D are exemplary scripts for use with the scripting system of FIG. 3, in accordance with an embodiment of the present invention.

Repeat use of reference characters in the present specification and drawings is intended to represent same or analogous features or elements of the invention.

### DETAILED DESCRIPTION OF ONE PREFERRED EMBODIMENT

Reference will now be made in detail to presently preferred embodiments of the invention, one or more examples of which are illustrated in the accompanying drawings. Each example is provided by way of explanation, not limitation, of the invention. It is to be understood by one of ordinary skill in the art that the present discussion is a description of exemplary embodiments only, and is not intended as limiting the broader aspects of the present invention, which broader aspects are embodied in the exemplary constructions. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

### System Environment

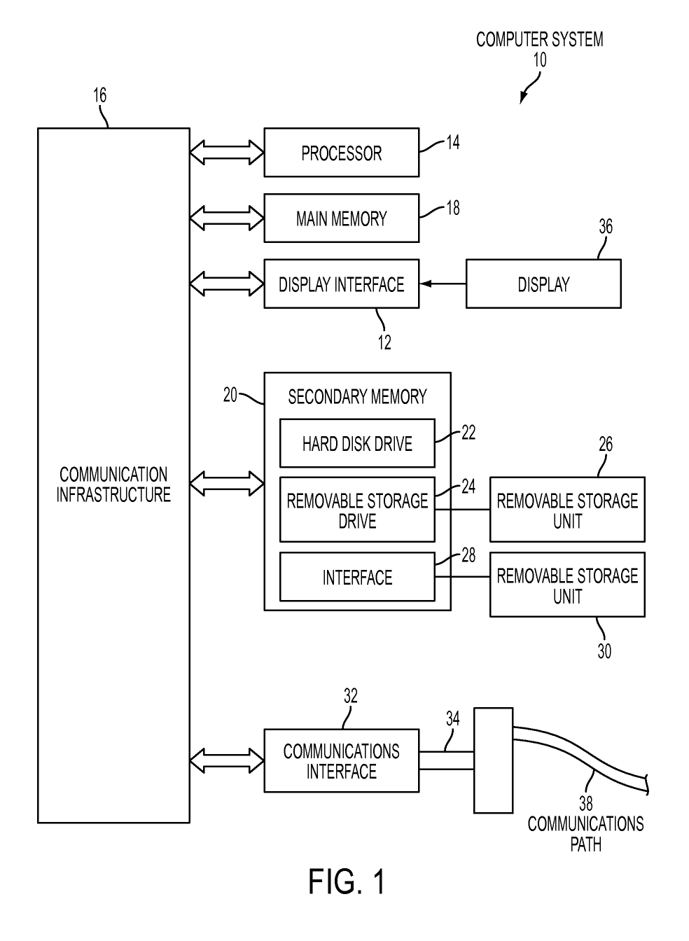

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 10 is shown in FIG. 1.

Computer system 10 includes one or more processors, such as processor 14. Processor 14 is connected to a communication infrastructure 16 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 10 can include a display interface 12 that forwards graphics, text, and other data from the communication infrastructure 16 (or from a frame buffer not shown) for display on display 36. Computer system 10 also includes a main memory 18, preferably random access memory (RAM), and may also include a secondary memory 20. Secondary memory 20 may include, for example, a hard disk drive 22 and/or a removable storage drive 24, representing a floppy disk drive, a magnetic tape drive, an optical disk drive, etc. Removable storage drive 24 reads from and/or writes to a removable storage unit 26 in a well known manner. Removable storage unit 26, represents a floppy disk, magnetic tape, optical disk, etc., which is read by and written to removable storage drive 24. As will be appreciated, the removable storage unit 26 includes a computer usable storage medium having stored therein computer software and/or data.

In alternative embodiments, secondary memory 20 may include other similar devices for allowing computer programs or other instructions to be loaded into computer system 10. Such devices may include, for example, a removable storage unit 30 and an interface 28. Examples of such may include a program cartridge and cartridge interface (such as that found in video game devices), a removable memory chip (such as an erasable programmable read only memory (EPROM), or programmable read only memory (PROM)) and associated socket, and other removable storage units 30 and interfaces 28, which allow software and data to be transferred from removable storage unit 30 to computer system 10.

Computer system 10 may also include a communications interface 32. Communications interface 32 allows software and data to be transferred between computer system 10 and external devices. Examples of communications interface 32 may include a modem, a network interface (such as an Ethernet card), a communications port, a Personal Computer Memory Card International Association (PCMCIA) slot and card, etc. Software and data transferred via communications interface 32 are in the form of signals 34, which may be electronic, electromagnetic, optical or other suitable signals capable of being received by communications interface 32. These signals 34 are provided to communications interface 32 via a communications path (e.g., channel) 38. Communications path 38 carries signals 34 and may be implemented using wire or cable, fiber optics, a telephone line, a cellular link, a radio frequency (RF) link and/or other suitable communications channels. In this document, the terms “computer program medium” and “computer usable medium” are used to refer generally to media such as a removable storage drive 24, a hard disk installed in hard disk drive 22 and signals 34. These computer program products provide software to computer system 10. The invention is directed to such computer program products.

Computer programs (also referred to as computer control logic) are stored in main memory 18 and/or secondary memory 20. Computer programs may also be received via communications interface 32. Such computer programs, when executed, enable computer system 10 to perform the features of the present invention, as discussed herein. In particular, the computer programs, when executed, enable processor 14 to perform the features of the present invention. Accordingly, such computer programs represent controllers of computer system 10.

In an embodiment where the invention is implemented using software, the software may be stored in a computer program product and loaded into computer system 10 using removable storage drive 24, hard drive 22, or communications interface 32. The control logic (software), when executed by processor 14, causes processor 14 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

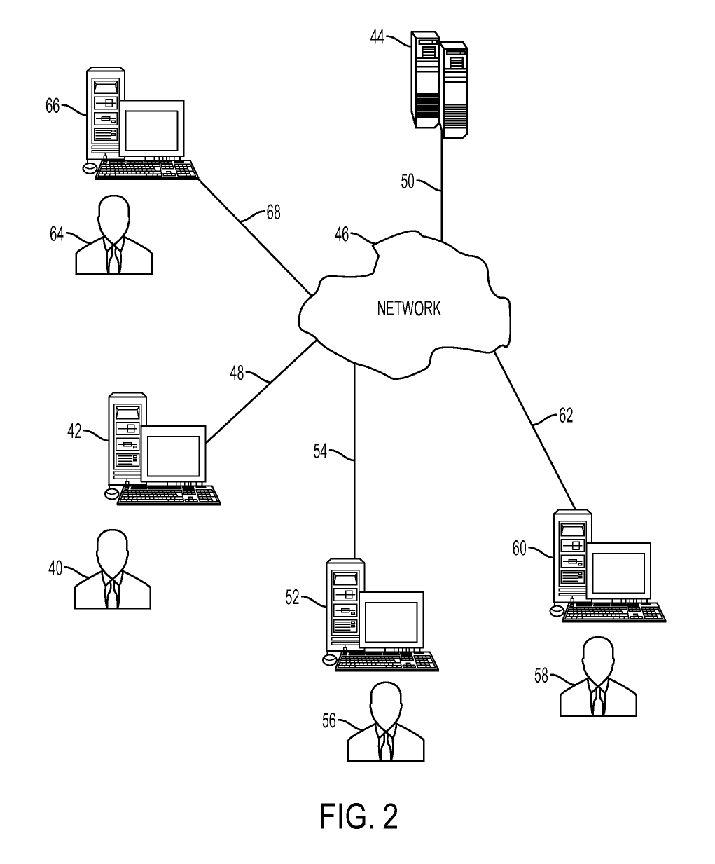

FIG. 2 presents an exemplary system diagram of various hardware components and other features in accordance with an embodiment of the present invention. Data and other information and services for use in the system are, for example, received from an end user 40 via a terminal 42. Terminal 42 is coupled to a server 44 via a network 46, such as the Internet, via couplings 48 and 50. In one embodiment, a vendor 56 also inputs information/data via a terminal 52 that is operatively coupled to network 46 via coupling 54. Furthermore, in one embodiment, a member of an outsourced workforce 58 can input information/data via a terminal 60 that is operatively coupled to network 46 via coupling 62, and in another embodiment, a member of a financial institution workforce 64 inputs information/data via a terminal 66 that is operatively coupled to network 46 via coupling 68. Each of terminals 42, 52, 60 and 66 comprises, for example, a personal computer (PC), minicomputer, mainframe computer, microcomputer, telephone device, personal digital assistant (PDA), or other device having a processor and input capability. Server 44 comprises a PC, minicomputer, mainframe computer, microcomputer, or other device having a processor and a repository for data or connection to a repository for maintained data.

In operation, according to an embodiment of the present invention, via network 46, vendor data, transactional data, sub-transactional data, order data, and/or other information are communicated with server 44. Server 44 receives and resolves transactions, including triggering and resolving sub-transactions, storing data regarding the transaction, vendor, and sub-transaction, and documenting the transaction (e.g., electronically). In one embodiment, the present invention uses active server page (ASP) technology to deliver information and services to a user. This embodiment may include one or more ASPs stored on server 44. Such approach reduces the maintenance expense and hardware expense, and results in limited implementation and integration costs, limited support expense, and low total cost of ownership.

### System Overview

The present invention provides systems and methods for interacting with customers during a transaction. The customer interaction is based on a controlled workflow that is generated by a scripting system. The scripting system pulls data from various disparate business systems, allows the user to launch business screens from the various disparate business systems and provides an interface to render back changes made by the user to the data that is stored in the various disparate databases.

The present invention is configurable to facilitate reaching a desired outcome of the business system and the method in which that desired outcome is achieved. Moreover, the present invention utilizes principles of behavioral influence in optimizing the path the system takes to achieve the desired outcome. For example,

1. the desired outcome may be the completion of a transaction, the sale of a product or service, the resolution of a claim or a debt or the resolution of a technical problem with respect to a purchased product;

2. the way in which the desired outcome is achieved may,
i. with respect to the sale of a product or service, include the price of the product or service being sold, the terms of the sale, the features offered in the product or service,
ii. with respect to a resolution of the outstanding debt, include the repayment terms, loan modification terms, etc., and
iii. with respect to technical support, be based on the customer's technical proficiency, complexity of the system, etc.

In addition to changing the desired outcome and/or the method in which the desired outcome is achieved, the present invention is highly configurable in real-time to optimize the path in which the desired outcome is achieved. That is, once the present invention obtains information from the customer, the present invention adjusts the predetermined scripted conversation to optimize the conversation based on (1) customer attributes such as the customer's psychological state or psychological traits (hereinafter “psychological factors,” (2) a change in the desired outcome based on the customer information and/or (3) a change in the method in which the desired outcome is achieved.

When the initial predetermined scripted conversation is generated the language and syntax chosen may be based on one or more behavioral sciences-based principles. As customer information is received in real-time, the scripting language and syntax may change to reflect the customer information. For example, if the desired outcome and method of achieving the desired outcome changes, then the scripting language will change. Moreover, whether or not there is a change in the desired outcome and method of achieving the desired outcome, the scripting language and syntax may change to further optimize achieving the desired result by completely changing the behavioral sciences-based principles applied to the scripted conversation, updating the scripted language to reflect changes in how the selected behavioral sciences-based principles are applied and/or to add additional behavioral sciences-based principles in addition to the selected behavioral sciences-based principles and change the language and syntax of how the old and new behavior sciences-based principles are applied. Thus, through manual or automated detection by the present invention, the predetermined scripted conversation is adjusted to optimize the conversation and address the perceived psychological factors of the customer.

For example, consider a direct sales context in which a travel agent is offering vacation options to a customer. The customer would provide a series of boundary conditions (i.e., for this example, that she wants to travel for at least one week to the Caribbean for around $1,000). The system will generate scripting language and syntax that is specific to the boundary conditions, but, moreover, it will generate a presentation of the information in a manner that is optimal with regard to the customer's psychological factors.

For instance, the initial choice set may leverage research in choice architecture to lead the customer to choose a particular option, a 10-day cruise to the eastern Caribbean, because this option has more available bookings Research in choice architecture suggests that people are more likely to choose a particular option, A₂, when it is presented with a choice set including options A₁, A₂, and B versus when it is presented alone. Thus, the system may create a choice set featuring a 7-day cruise to the western Caribbean for $1,200 (A₁), a 10-day cruise to the eastern Caribbean for $1,000 (A2) and a 10-day hotel stay in St. Kitts for $1,000 (B). The choice between the two cruises is relatively clear, assuming that the customer has no clear preference between eastern and western Caribbean, so she would almost invariably choose the cheaper 10-day cruise. Because the 10-day cruise was such an easy choice compared to the other cruise, the customer would interpret the ease of the choice between the two options as a sign of her preference for the 10-day cruise, even in comparison to the hotel stay, since it did not have as direct of a comparison point.

However, if upon hearing the three options, the customer tells the agent that she gets seasick easily, the hotel is her only option even though it does not seem like as good of a deal when compared to the cruise. The system would generate a new set of scripts using research in other areas of behavioral sciences to follow-up to the customer's choice. For instance, it would use research from the study of temporal changes in heuristic processing. Research suggests that people value experiential purchases more in the distant future and distant past, so if the trip was to be taken in 6 months, the system would generate a description of all of the varied excursions and cultural immersion opportunities that the hotel provides. However, if the trip was last minute, the system would not add this statement since it would not be as powerful. Instead, it may generate a follow-up script that leverages the social proof technique to describe, in detail, the high number of positive feedback ratings the hotel has received. The inclusion of the behavioral sciences research in the follow-up scripting would lead the customer to choose the hotel stay in this context.

The dynamic, real-time customization of messaging to the customer would allow the agent to make a compelling and effective presentation given the customer's mutable psychological factors, which in turn provides a standardized method of optimizing the ability to provide a tenable solution that converts to a sale for the agent and generates excitement in the customer.

For purposes of this invention customer should be interpreted to mean any individual or business to which a user seeks to elicit a desired outcome. For example, a customer may be a customer, a potential customer, a business partner or information seeker. Moreover, a user may be a person or an automated system that executed a communication.

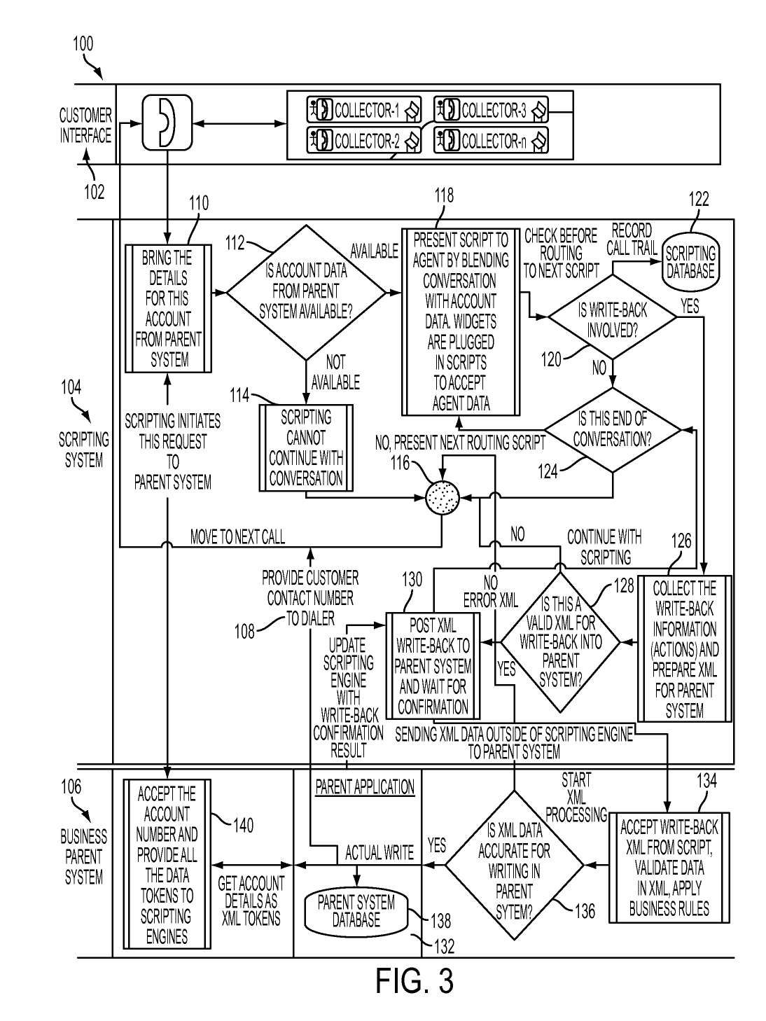

Referring to FIG. 3, one embodiment of a customer management system (CMS) 100 in accordance with the present invention is shown as an end to end communications model for a customer oriented business platform. The CMS has a customer interface 102, a scripting system 104 and one or more business parent systems 106, which are applications that process data with their own business application logic. Customer interface 102 may be, but is not limited to, a dialer, web interface a handheld device application, etc. Moreover, business system 106 may be any underlying business program used to provide customer service support such as REALSERVICING®, NCI™ Collection and may also include business systems that use analytics to model customer behavior. For example, customer analytics is a process by which data from customer behavior is used to help make key business decisions via market segmentation and predictive analytics.

In one preferred embodiment, scripting system 104 is a standalone independent system that is not designed for any one business system 106 but, instead, is flexible in that it can be configured, without recoding or recompiling the software, to work with any business system 106 that can read and write data in extensible markup language (XML). XML is a markup language designed to carry data with undefined tags (tokens) that are self-descriptive. For purposes of the present invention, the term “tag” is used interchangeably with the term “token.” Moreover, the term “token” for purposes of the present invention means a placeholder which can be replaced appropriately with business data, a user interface element, a business rule or a conversation routing. It also represents itself as a data exchange format. Said another way, a token represents a unit of business information that can be used to create meaningful conversations in a script. Tokens also extend themselves for collating information that will be used for event exchange between the scripting system and a parent business system. Examples of tokens include, but are not limited to, base tokens that are obtained from the parent business application, widget tokens that assist in capturing end user business information through graphical interfaces which can also be used in dynamic routing of scripts based on the captured values, user defined tokens that help in defining static values which are not specific to a conversation but are specific to the business application, system defined tokens that maintain constant value with a limited conversation scope, and function tokens that help the scripting administrator to derive additional values using base and widget tokens along with evaluators and expressions of functions. Function tokens also acts as rules for controlled data display and aid in conditional routing scenarios between scripts for a complete end to end conversation.

XML provides structure and stores and transports information. Scripting system 104 has the ability to talk with any disparate business system 106 through XML. By using XML as the interaction layer, scripting system 104 is configured to interact with multiple disparate business systems 106 irrespective of their technologies so long as the business systems can read and write data using XML. In this way, scripting system 104 makes a data request using a token, the business system accepts the read request, processes the read request and returns an XML with the token and its associated values. In some preferred embodiments, scripting system 104 collects information from the customer and formats the information for transmission to the business system. Scripting system 104 converts the formatted information into XML with associated tokens and posts the information to the business system. The business system receives the XML and processes the write-back request. Scripting system 104 may also be configured to launch screens from the various associated business systems to allow the user to work with the business systems to produce various calculations, view reports, etc.

In the present invention, the XML format contains two parts-a header portion and a data carrier portion. The header portion contains information specific to the transaction such as a transaction ID number, a key, etc. to track the customer interaction. The data carrier portion contains the token and the associated data value. In some embodiments, each token is associated with a data field in the various databases of the business systems. In other embodiments, token values in the scripting system may represent new database fields not yet in existence in the various business system databases. In these embodiments, when scripting system 104 performs a write-back to the various business systems, a new token value not representative of a data field can be used to create new data fields in the various disparate data bases of the associated business systems.

It should be understood that other data formats may be used in place of XML. For example, any suitable data format that contains a unique customer identifier, a data tag and a data value assigned to the data tag may be used, where the data tag is associated with a field in a database.

Business system 106 integrates with scripting system 104 by providing a read communication interface that allows scripting system 104 to fetch required data for scripting integration and a write communication interface to accept data from scripting system 104 to update customer records and to carry out business system tasks. Business system 106 is configured to feed data to customer interface 102, for example, a phone number to customer interface 102, for example, in an outbound calling campaign, and an account ID or other suitable unique identifier to scripting system 104. Based on the unique identifier received, scripting system 104 requests customer data and various other business related data from business system 106. Business system 106 receives the account request from scripting system 104 and formulates token values that are passed back to scripting system 104 for blending the received data associated with the tokens into a particular script used to interact with customers. Scripting system 104 also collects data during interactions with the customer and forwards the collected data back to business system 106 in real-time for updating data tables or for doing data processing using business logic (analytics) so that business system 106 can take appropriate action based on the data collected and send updated information to scripting system 104 so that changes in the desired outcome or the scripted conversation can be adjusted accordingly.

For discussion purposes, and still referring to FIG. 3, business system 106, is a REALSERVICING® loan servicing system manufactured by Altisource Solutions S.à r.l. of Luxembourg and customer interface 102 is an ASPECT® UIP dialer manufactured by Aspect Software, Inc. CMS 100 helps to streamline external customer contacts, provides structured interaction between the organization and the customer and increases customer satisfaction, reliable communication and increased compliance with the business systems.

In FIG. 3, a general flow process of CMS 100 is shown where the CMS system is used to make and receive customer contacts. A customer contact begins at step 108 where scripting system 104 causes a new call to be initiated by receiving a customer contact number and passing the number to customer interface 102. At step 110, scripting system 104 requests account details from business system 106 that are associated with the customer contact number. At step 140, business system 106 accepts the account number from the scripting system, retrieves account detail from the business system application 132, which sends the data formatted in XML. It should be understood that any type of account reference may be used to request account details and is not limited to an account number. The account data may come from one or more business systems and may contain customer info, business rules, data flags, or any other relevant information to the customer contact. At step 112, the scripting system checks to see if the account data is available from the business system. If data for the customer is not available, then at step 114 the scripting system determines that it cannot move forward with the customer contact and proceeds to stop the current contact at step 116. Thereafter, a new customer contact is initiated by passing new customer contact information to customer interface 102.

If, instead, account data for the customer contact is available from the business system, at step 118, script system 104 develops a preconfigured customized conversation based on one or more scripts that are specific to the customer data, data flags, etc. retrieved from one or more business system databases. That is, prior to the user communicating with the customer, a complete preconfigured customized conversation is created by scripting system 104 to provide or obtain necessary information to meet the caller's needs, obtain customer information that is missing from the customer data, etc. Each preconfigured customized conversation is dynamically determined based on customer information, data flags, etc. stored in the database(s). Moreover, each preconfigured customized conversation may or may not be the same between different customers and may vary accordingly based on each customer's data.

At step 118, a script from the preconfigured customized conversation is presented to the user by blending the script with account data associated with the data retrieved at step 110. Blending occurs by using token references in the script that allow the customer data associated with the token to populate directly into the script. At step 120, before the scripting system moves to the next script, the system checks to determine if updated data received by the user needs to be written back to the business system. Also at step 120, the system records a record call trail to the scripting database, at step 122. If no write-back is involved at step 120, the scripting system checks, at step 124, to determine if the customer contact has reached an end or if another script is available. If the customer conversation is at a stopping point, the scripting system proceeds to stop the current customer contact, at step 116, and a new customer contact is initiated. Otherwise, the system will present the next script in the conversation to the user, at step 118, and the process repeats.

If on the other hand, at step 120, a write-back of data is necessary, the scripting system, at step 126 collects the write-back data information and prepares an XML to be transferred back to the business system. At step 128, the scripting system confirms whether the write-back XML data is valid, and if so, the valid XML for the write-back data is posted to the business system, at step 130. At step 134, the XML data is accepted by the business system, is validated and business rules are applied to the write-back data as necessary. At step 136, the processed XML data is checked for accuracy and is written to the business system database at step 138. The scripting system is updated with a write-back confirmation and the scripting system returns to step 124 as described above. If, on the other hand, at step 128, the write-back XML data is not valid, the scripting system terminates the customer contact at step 116.

### Scripting System Overview

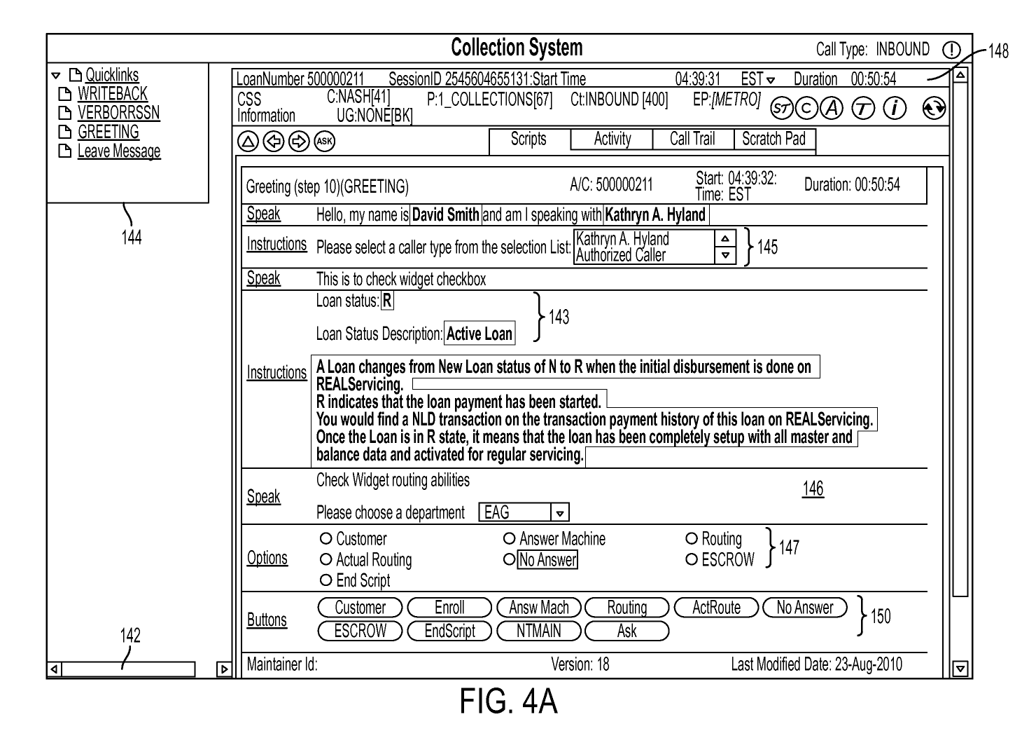

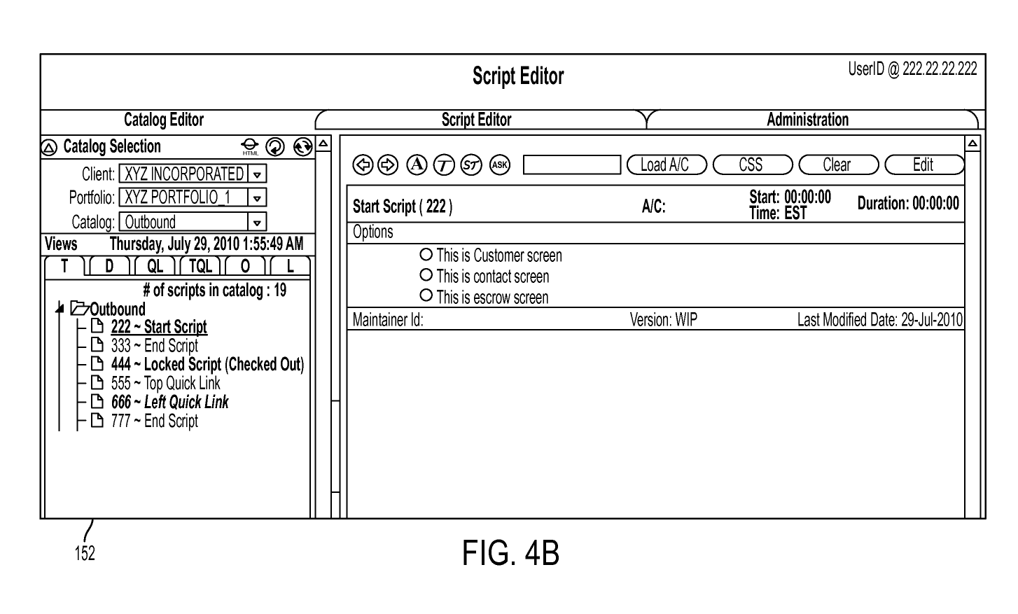

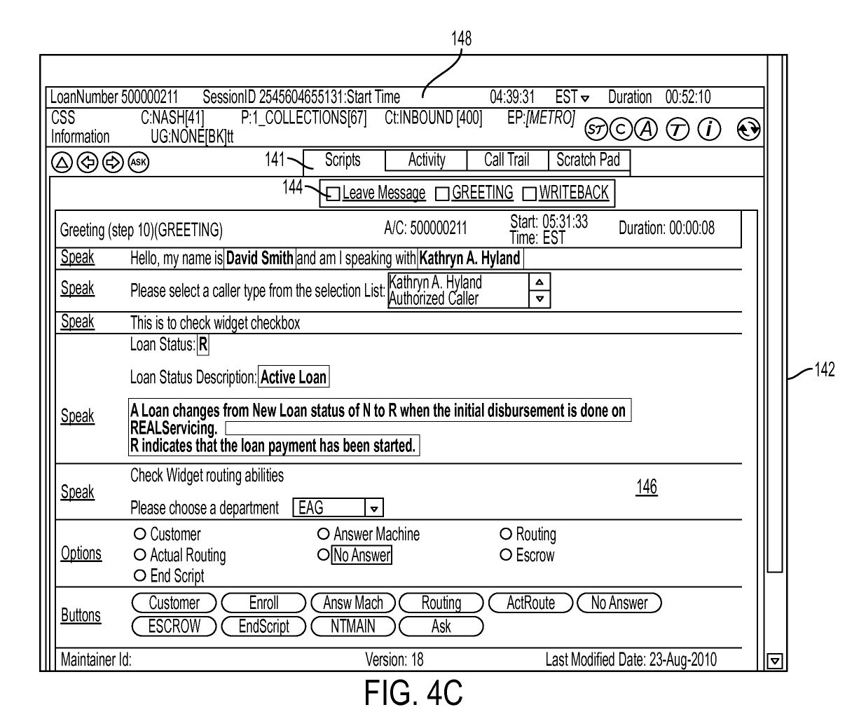

Referring to FIGS. 4A and 4B, scripting system 104 (FIG. 3) is comprised of a script interface window 142 (FIG. 4A) and a script editor interface 152 (FIG. 4B). Referring particularly to FIG. 4A, script interface window 142 pops up when customer contact is initiated, whether by inbound contact from the customer or by outbound contact from the user, and provides an interface with standardized scripts for the agent to interact in a predefined manner using standard verbiage with the customer. Relevant scripts corresponding to various aspects of the customer account status along with the ability to navigate between relative scripts are provided. Scripting system 104 allows the user to launch business screens from a particular script during conversation and also provides an interface to render back changes made by user to other disparate software systems, for example REALSERVICING® or other suitable systems used in customer service, product ordering, product support, etc. That is, scripting system 104 has the ability to accept user entered values into scripting during a customer contact and provides for transfer of those inputted values into the proper customer related files stored in various business system databases. Additionally, the data can be received in parallel from multiple disparate databases and can also write-back data to multiple disparate databases in parallel and in real-time.

Each preconfigured customized conversation script generated by the system comprises a script flow area 146 that is defined as a logical flow of conversation between the user and the customer. A script is defined as an entity containing multiple dialogs. A dialog is an entity consisting of speech text 143, instructions 145, one or more options 147, and one or more links or buttons 150. Speech text 143 is defined as the sentence spoken or provided to the customer by the user. Instructions 143 are the directions provided to the user and are usually specific directions for addressing a particular situation in a customer contact. Options 147 are something that the user can choose to do in preference to one or more alternatives to achieve a desired result. Options may be the possible selections that a user can make in response to a customer's input. The selection of an option may result in a script expansion or may lead to the next script in accordance with the selection. Links or buttons 150 are defined as a connection that takes the flow to the next logical script.

To form a script, multiple dialogs are interconnected within a script to provide a complete conversation of that script. Apart from the starting and ending scripts, all intermediary scripts have a parent and a child script(s). The starting script has only child scripts and the ending script has only a parent script. Scripts move one to the other through links, and each script has a mandatory script key and script name. It should be noted that, although a preconfigured conversation is created based on the customer data and data flags stored in the business system(s), prior to the user communicating with the customer, the preconfigured conversation may be adjusted in real-time during a customer contact. That is, as the user interacts with the customer and new data is obtained and entered into scripting system 104, the scripting system will process the new data and adjust the preconfigured conversation in real-time to reflect the new data. Consequently, script flow can dynamically change as the customer contact progresses and may not be the same script flow from one customer to the next.

Referring to FIG. 4B, script editor interface 152 allows administrators to create business process workflows and scripts and then change them in real-time to improve productivity without interrupting customer service operations. The flow of interaction is determined entirely by the script, and not by the user or the customer. Script editor interface 152 provides the ability to define new functions, and also to edit and execute them at run time according to business rules.

Referring to FIG. 4C, a script interface window 142 is displayed when a script tab 141 is clicked. Script interface window 142 has quick links 144 that allow the user to leave a message with the customer, pull up a greeting or write-back information gathered by the user from the customer to the business system database. The quick links may be on the left side of the script interface window as shown in FIG. 4A or they may be along the top of the script interface window as shown in FIG. 4C. Script flow area 146 provides the user with pre-established conversation that is used to provide and gather information relevant to the customer contact. An information bar 148 provides the user with customer contact information, i.e. account number and in the case of a customer call the start time and the end time of the call. Various input buttons 150 (FIG. 4A) are provided to the user to carryout functionality related to the customer contact. The listed quick links and input buttons may be added to, removed or modified by an administrator using the scripting editor interface 152 (FIG. 4B).

### Scripting System Operation Overview

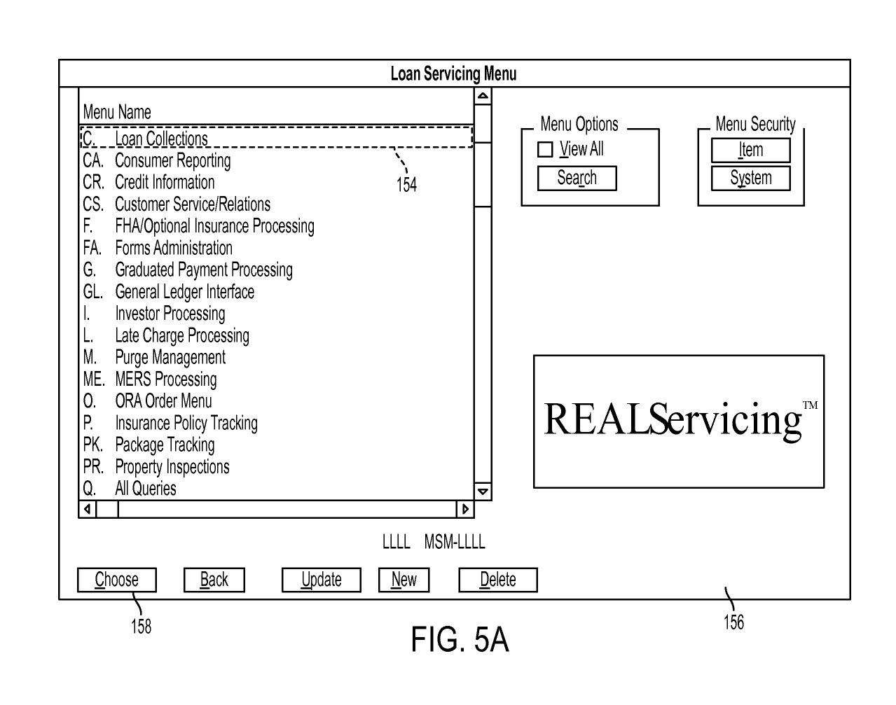

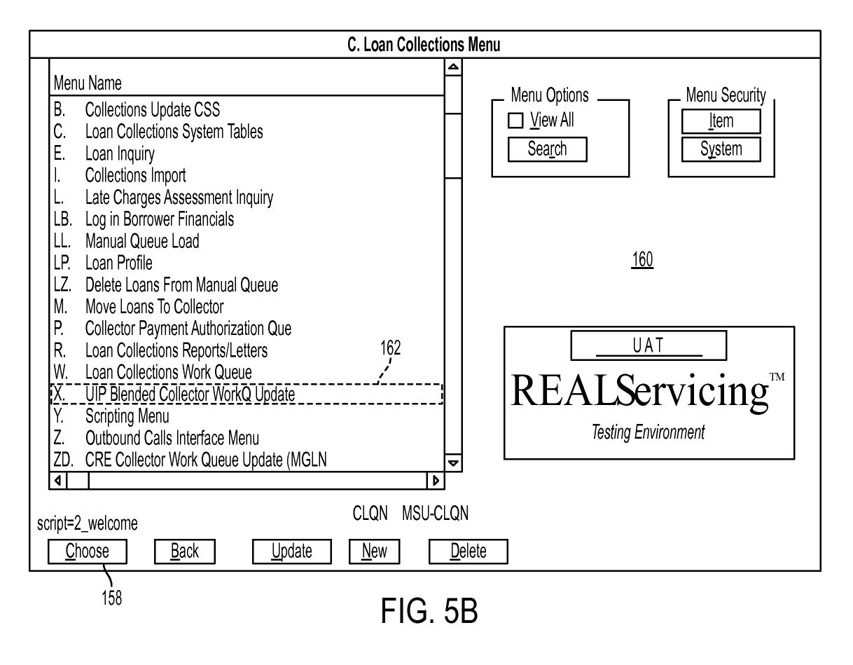

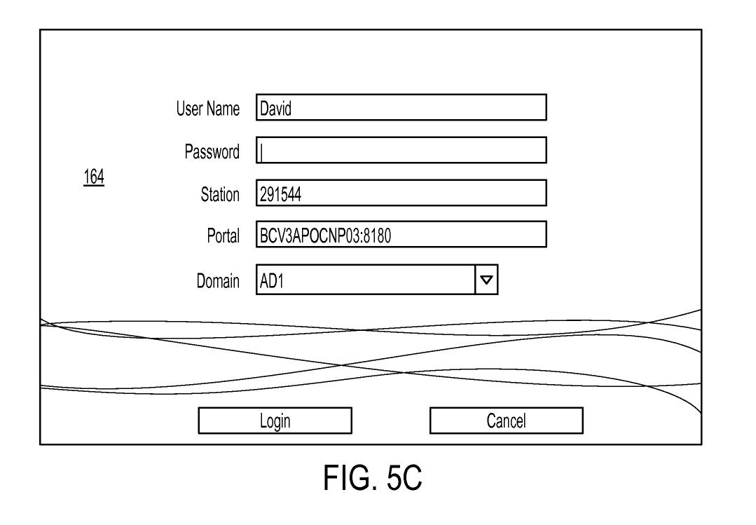

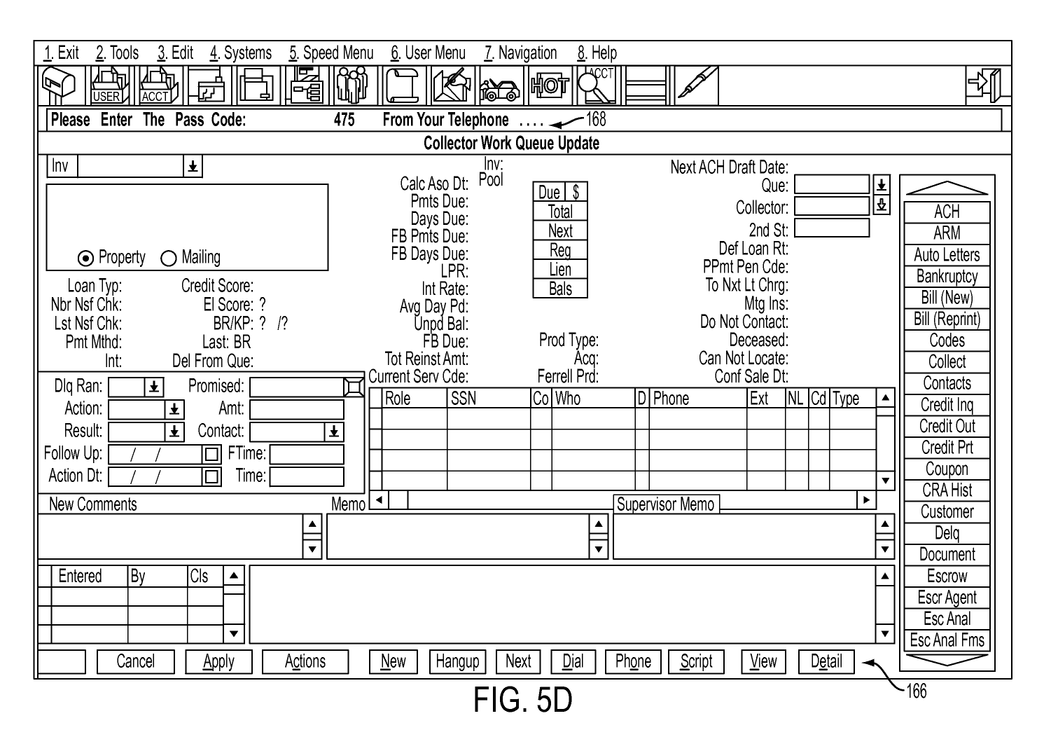

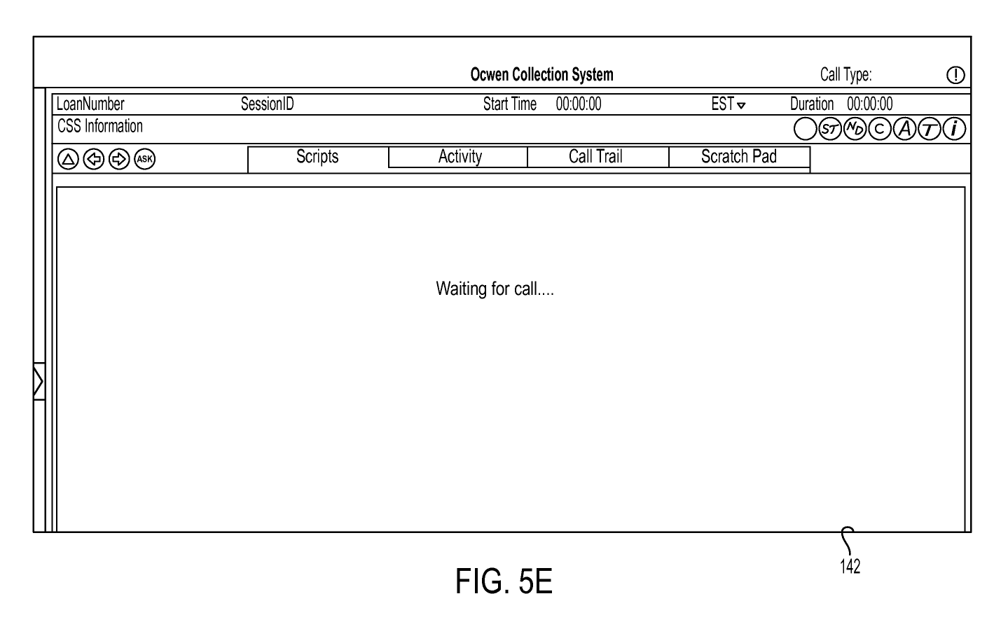

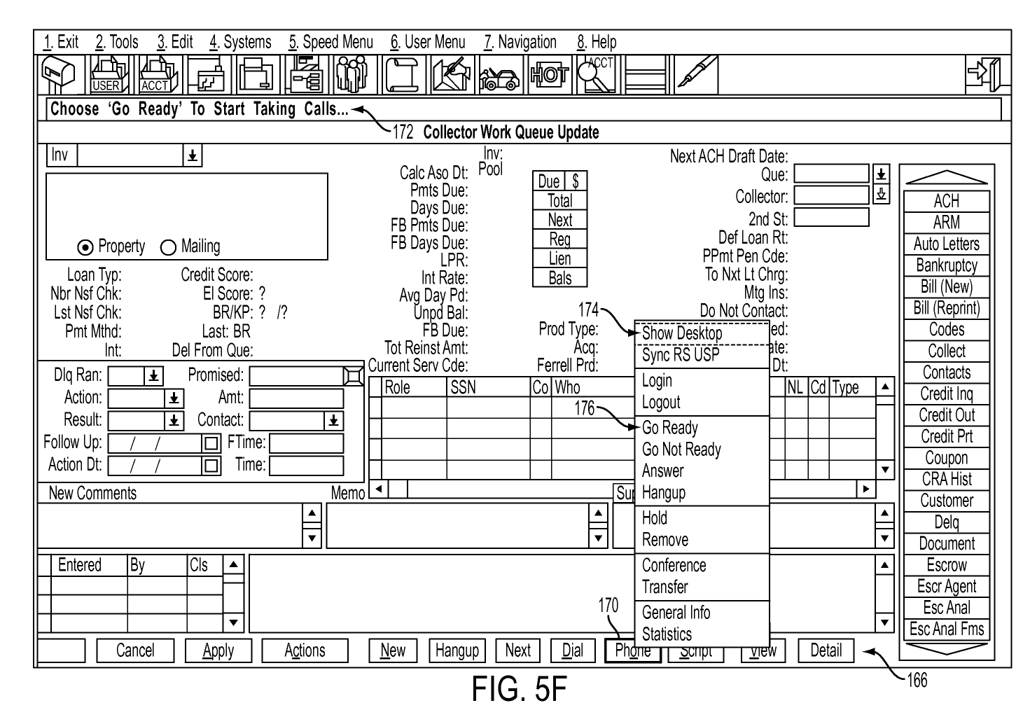

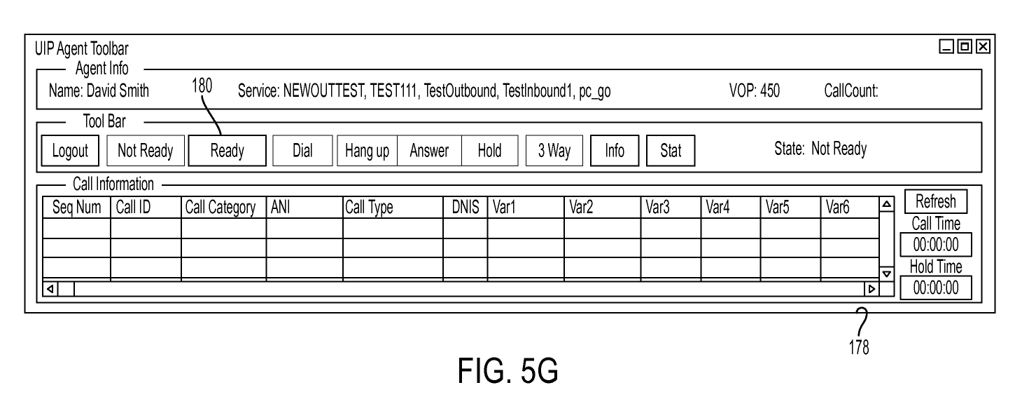

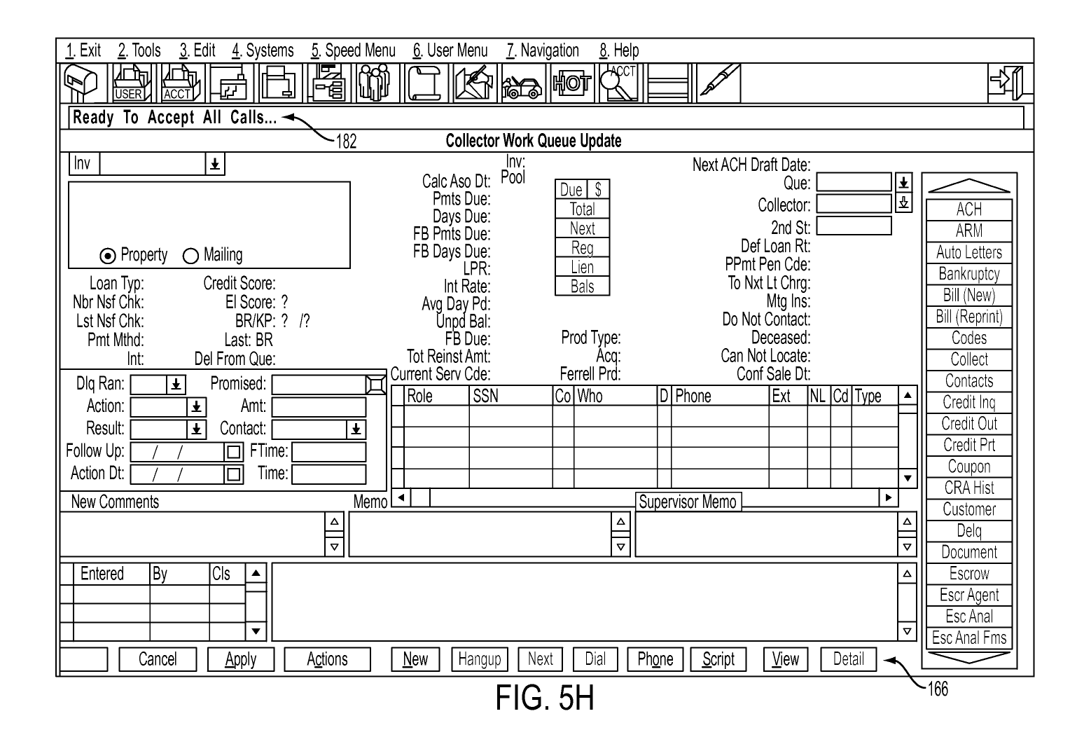

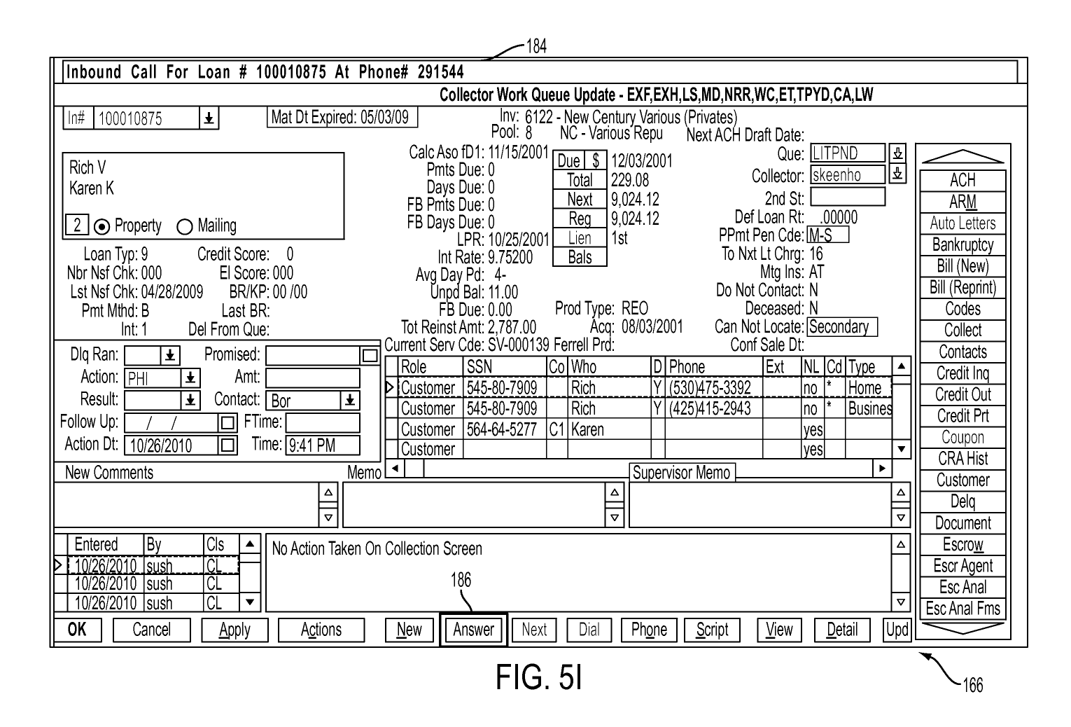

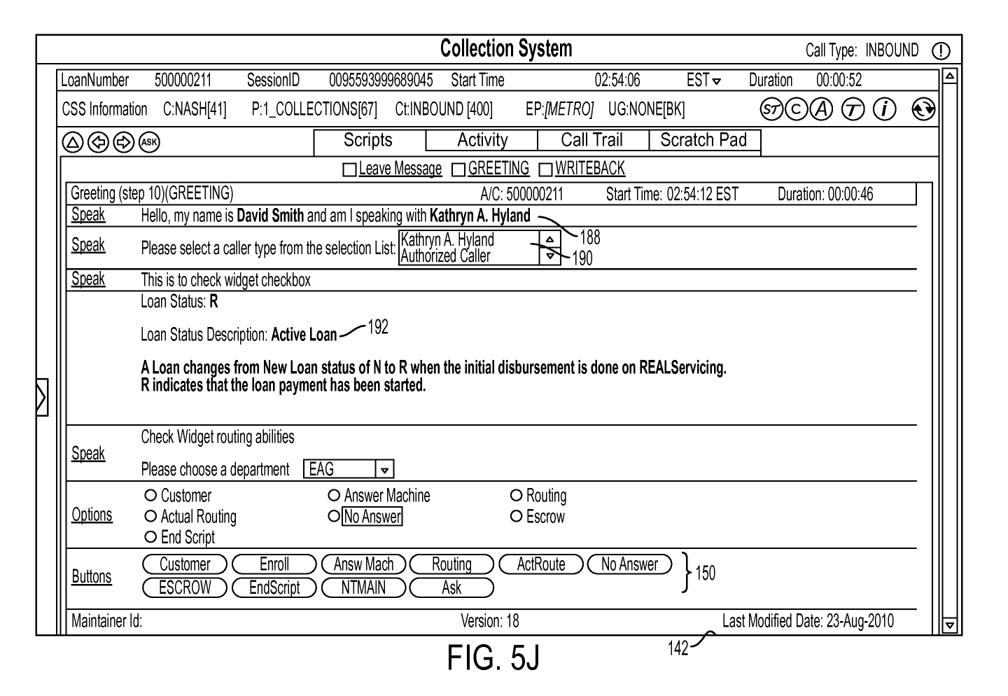

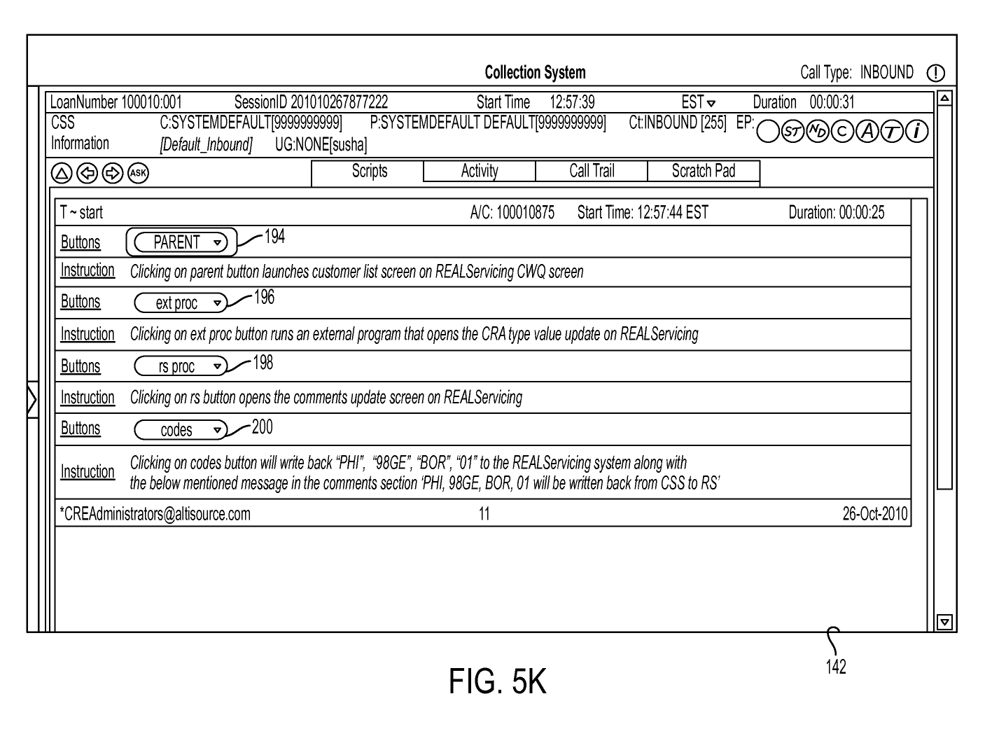

Referring to FIG. 5A-5J, the user login sequence is presented for one preferred embodiment of a CMS system having a automated telephone dialer as customer interface 102 (FIG. 3), scripting system 104 (FIG. 3) and a REALSERVICING® mortgage solution by Altisource Solutions, S.à r.l. as business parent system 106 (FIG. 3). A user begins using CMS system 100 (FIG. 3) by logging into business parent system 106. The user selects a loan collections function 154 from a loan servicing menu 156 and clicks a choose button 158. Next referring to FIG. 5B, a loan collections menu 160 is displayed so the user can select the UIP Blended Collector WorkQ Update selection 162 and click choose button 158. Once the choose button is selected, the scripting system activates the automated dialer login screen 164 (FIG. 5C) for the user to provide their login credentials. In one preferred embodiment, the auto dialer system is manufactured by Aspect Software, Inc.

Referring to FIG. 5D, once the user logs into the auto dialer system, a collector work queue update window 166 opens with a message “Please Enter the Pass Code 475 From Your Telephone” 168 at the top of the window. This pass code is used to connect the user's telephone to the auto-dialer system so that calls received by the user are synchronized to the customer information displayed in the scripting system. Referring to FIG. 5E, once the pass code is entered by the user, script interface window 142 is activated and launched on the user's desktop. At this point and referring to FIG. 5F, the user returns to collector work queue window 166 and is provided with a message 172 that states “Choose ‘Go Ready’ to Start Taking Calls . . . ”. The user clicks a phone button 170 that opens a drop down menu 174 to allow the user to select the “Go Ready” menu item 176. Once the “Go Ready” menu item is selected, a UIP agent toolbar screen 178 (FIG. 5G) opens so that the user can select a “Ready” button 180. Once “Ready” button 180 is clicked, collector work queue update window 166 updates with a message “Ready to Accept All Calls . . . ” 182 (FIG. 5H) at the top of the window. At this point, the user is ready to begin taking calls from customers.

Referring to FIG. 5I, once a call is received and transferred to the user, collector work queue update window 166 updates, a message “Inbound Call for Loan #XXXXXXXXX at Phone #XXXXXX” 184 is shown at the top of the window, and an answer button 186 on the collector work queue update window and an answer button (not shown) on the UIP agent toolbar screen activates to allow the user to answer the inbound call. Referring to FIG. 5J, when the answer button is clicked on either the collector work queue update window or the UIP agent toolbar screen, script interface window 142 opens and contains a script that is specific for the product or service supported by business parent system 106. Thus, when an inbound call is initially received, script interface window 142 presents a greeting script to the user. The greeting script will include introduction language 188 and a selection box 190 to input the type of the incoming caller—the person on the account, an authorized caller, etc. In addition to the above, other customer account information is provided such as the status of the customer's loan 192 and buttons 150 that allow the user, for example, to route the call, end the script, check escrow information, etc. As the call progresses, one or more scripts are used to present and collect data that is used by scripting system 104 to drive the conversation and by business parent system 106 to resolve the call.

In some embodiments, the scripting system is configured to allow the collected data and call resolution to be written back to the business system or various other databases associated with the business system. Thus, referring to FIG. 5K, once the call is terminated, script interface window 142 presents the user with various buttons to finalize the call. Examples of soft buttons include, but are not limited to, a parent button 194, an external program button 196, a REALSERVICING® comments update button 198 and a codes button 200. When parent button 194 is selected, scripting system 104 launches the business parent system 106 so that the data collected by scripting system 104 may be updated in one or more of the business systems. An ext proc button 196 opens the CRA type value update screen on the business parent system. An rs proc button, when selected, opens a comments update screen in the REALSERVICING® business system. Finally, a codes button 200 causes a write-back of codes to the business system. It should be understood that buttons 194, 196, 198 and 200 are specific to REALSERVICING® business system and that these button will be different depending on the business system(s) used in combination with scripting system 104.

With regard to the above described embodiment, the user must log into the dialer, the scripting system and the business system separately. In other embodiments, scripting system 104 would be the single interface for the user and logging on to the scripting system would also log the user into the customer interface and the various business systems used as part of CMS 100. In this way, the user need only be familiar with the graphical user interface of scripting system 104 and need not have any knowledge about customer interface 102 or the various business parent systems 106. As a result, use of the scripting graphical user interface for all user interactions reduces the amount of training that is necessary for new employees and for rolling out updates to the various systems.

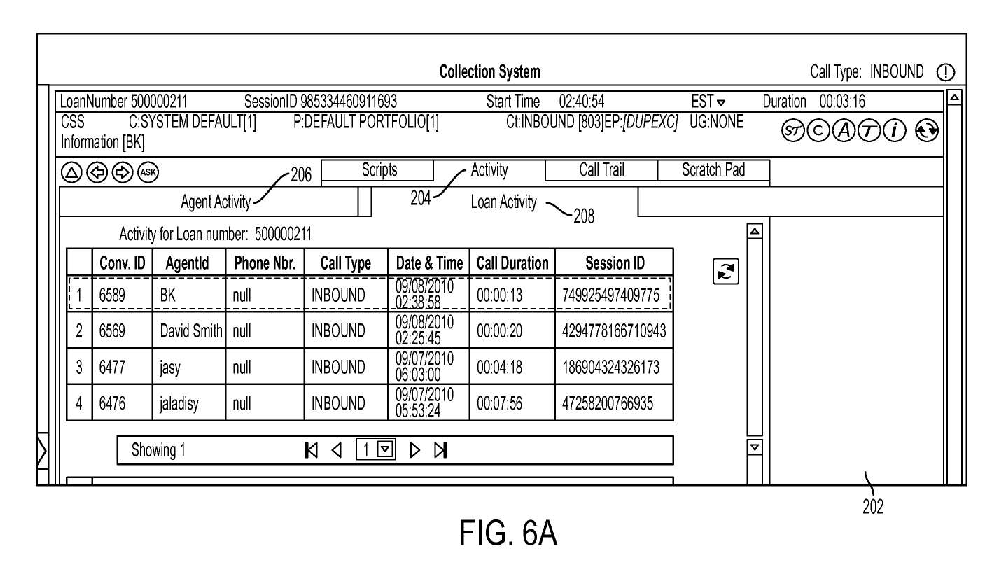

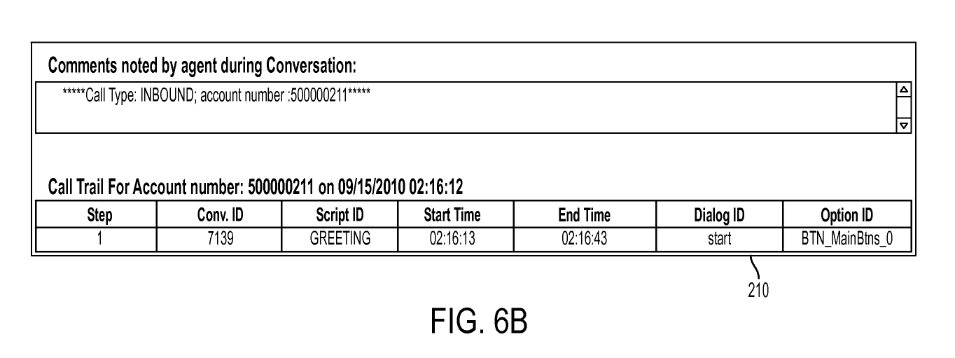

Referring to FIG. 6A, an activity user interface 202 is presented when the user selects an activity tab 204. The activity user interface allows the user to either select an agent activity tab 206 or a loan activity tab 208, which respectively list the loans serviced by the agent or all loans serviced by CMS 100. By double clicking the loan number a call trail screen 210 (FIG. 6B) is launched that presents the call trail for a particular communication with the customer. The same feature is available under the agent activity tab.

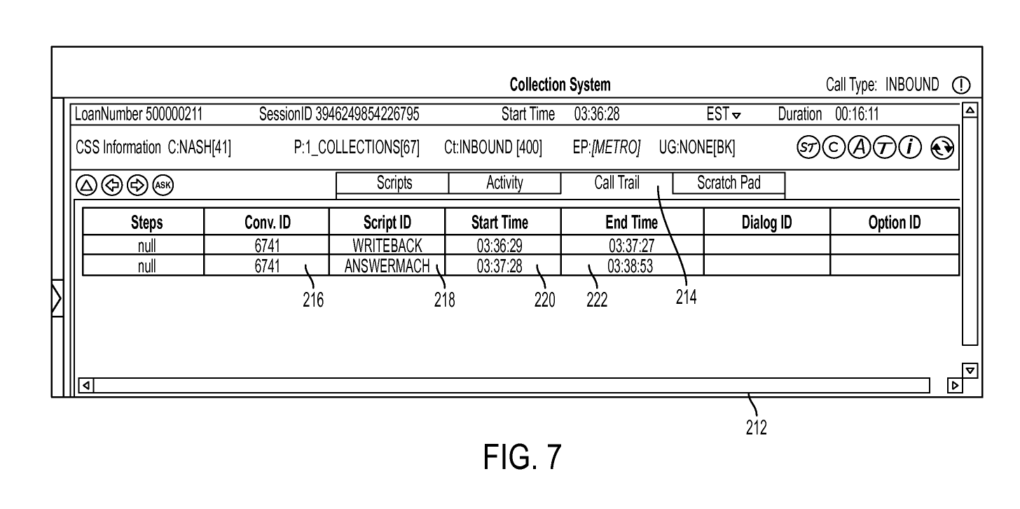

Referring to FIG. 7, a call trail user interface 212 is shown that the user can select by clicking on a call trail tab 214. Call trail interface 212 presents the user with details about a particular customer communication. For example, the call trail is listed by conversation ID number 216, script ID 218, call start time 220 and call end time 222 and various other customer contact specific information. It should be understood that these call trail attributes can be adjusted based on the type of customer interface and business system that are interfaced with the scripting system. The call trail includes information in each script, the beginning and ending time of when the script was used, information about what data was collected when the script was used as well as other data related to the customer interaction that can be used for quality control purposes.

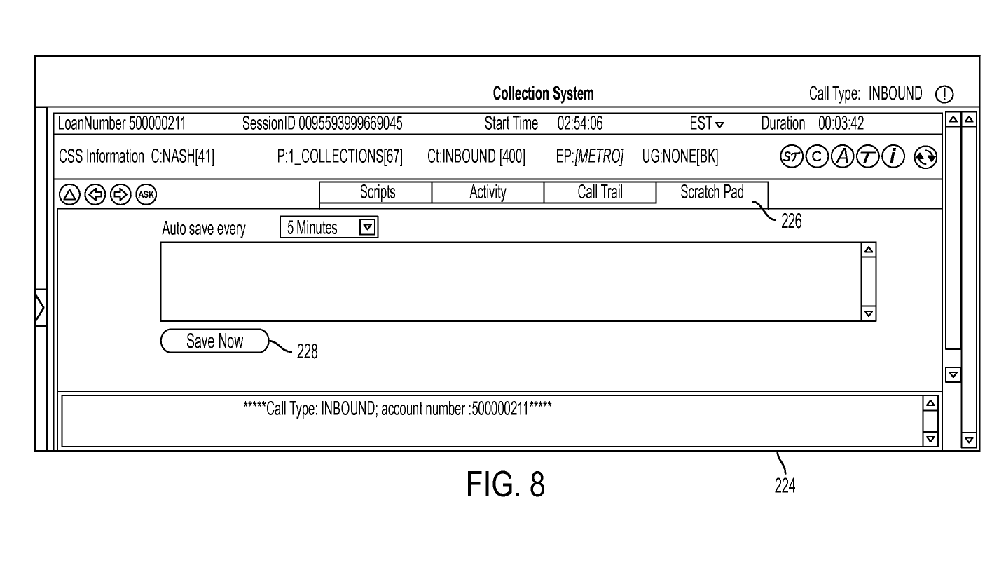

Referring to FIG. 8, a scratch pad user interface 224 is shown that the user can select by clicking on a scratch pad tab 226. The scratch pad allows the user to enter notes, customer questions or other information that is relevant to the customer contact. By clicking a save now button 228, the information entered into the scratch pad is saved to the business parent system and is associated with the customer account. With respect to FIGS. 4A-8, the above described features describe one embodiment of scripting system 104 when used in conjunction with an auto dialer and the REALSERVICING® business system for managing and servicing mortgages.

As previously mentioned, scripting system 104 is a self-contained and independent system that interfaces with one or more disparate business parent systems 106 and a customer interface 102. The system allows an administrator to create any scenario necessary for its intended use in CMS 100 without recoding and recompiling the system software. Using the script editor interface 152 (FIG. 4B), the system administrator can create new scripts and modify existing scripts. Scripting system 104 is advantageous because it provides an interface for creating, editing and deleting scripts and to publish those scripts during production, thereby reducing the complexity in how scripts are managed. By scripting the flow of a customer communication and embedding that into the communication process, users are guided through the communication in a predictable manner resulting in consistent interactions with customers. This reduces errors and complaints, increases effectiveness and produces uniformity of output.

Through accurate version management and history details, scripting system 104 better organizes and provides insight into a script's evolution. Scripts may be modified, edited or created and then circulated for testing by a small group of users, for a limited time period, to determine whether the changes had any significant impact on the overall functionality of the system. Once tested, scripts can be published and placed into production.

### Scripting Editor Interface

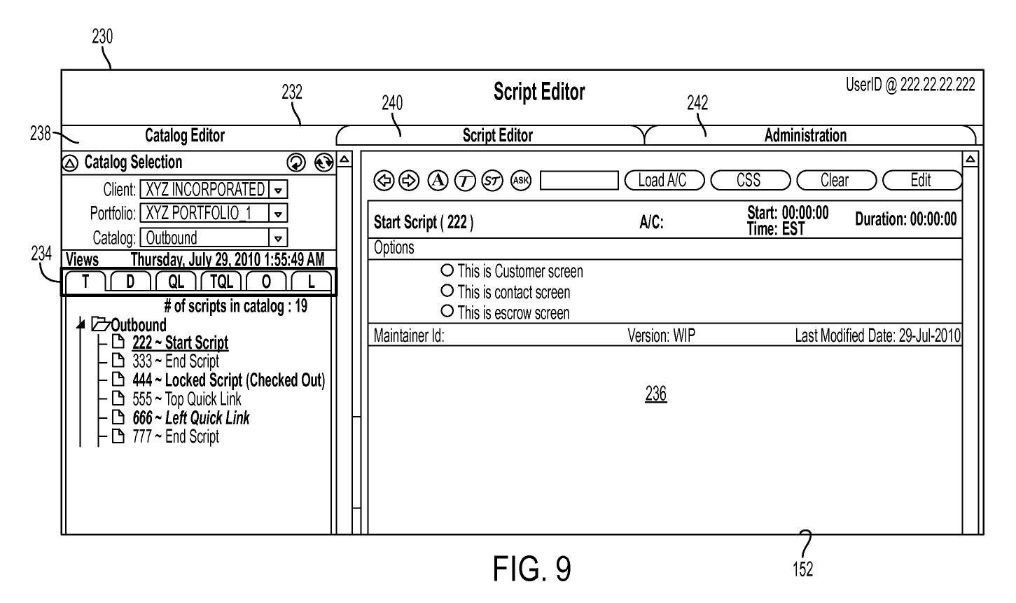

Referring to FIG. 9, script editor interface 152 has a logo area 230, a header area 232, a pallet 234 and a work area 236. Script editor interface 152 contains three modules-a catalog editor 238, a script editor 240 and an administration utility 242. Script editor module 240 allows an administrator to create new scripts and edit or delete existing scripts. Catalog editor module 238 allows the administrator to manage scripts used in production. It provides publishing, comparing, importing, editing and deleting of scripts. The catalog editor module also allows the administrator to manage portfolios of clients in a client list. Finally, the administration module 242 allows the administrator to administer the script editor interface.

### Catalog Editor Module

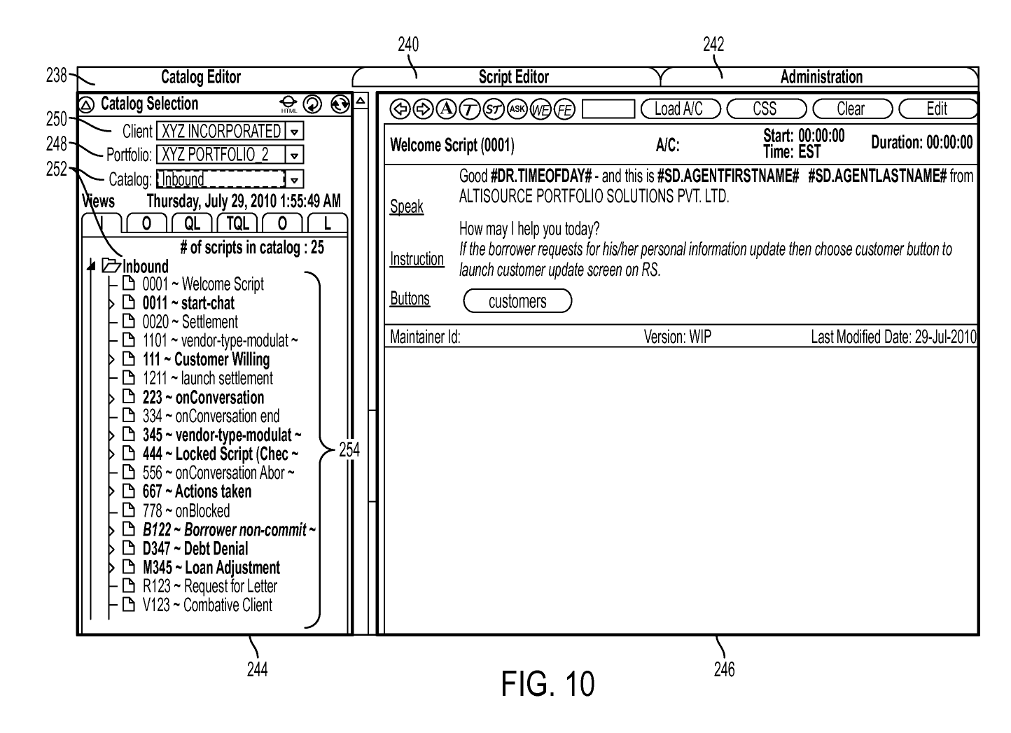

Referring to FIG. 10, catalog editor module 238 has a catalog management pane 244 and a script testing window 246. Catalog management pane 244 contains all links to the scripts of a catalog from a portfolio 248 of a client 250 available in scripting system 104. When a client is created in scripting system 104, a default portfolio is created for the client, which may contain one or more catalogs for scripts. When a new catalog is created, it will not contain any scripts. Scripts may be imported from other catalogs in the system depending on the utility and requirements of the client. When a catalog 252 is selected for a portfolio, the catalog is listed in catalog management pane 244 in a tree format. Various scripts 254 are listed below the catalog base folder.

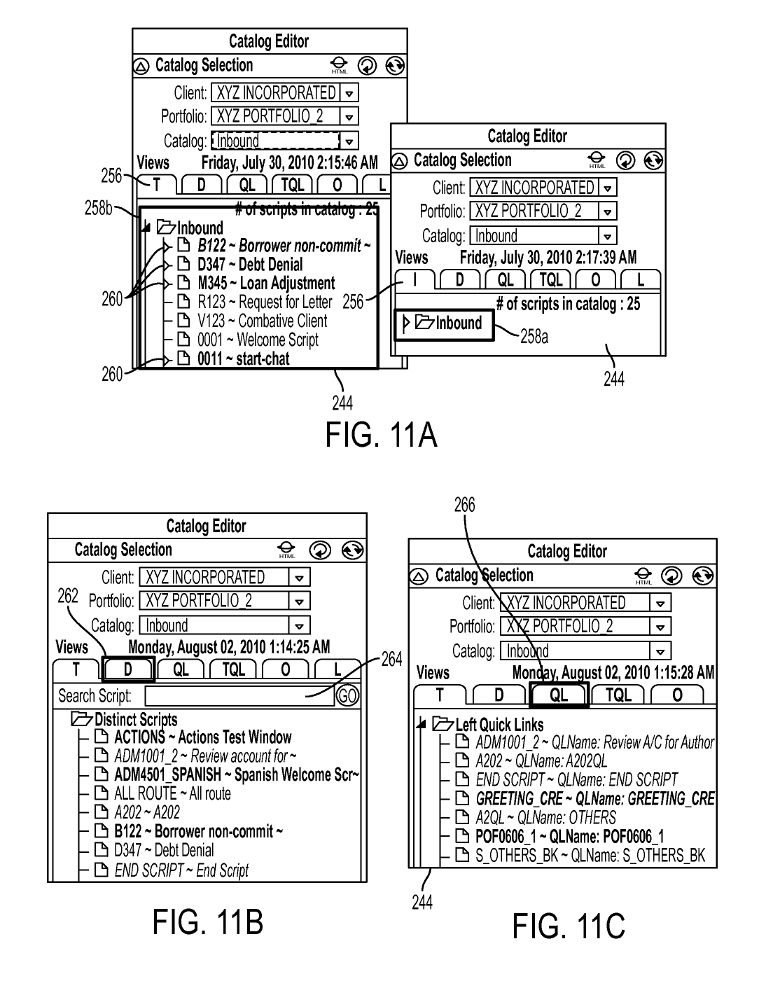

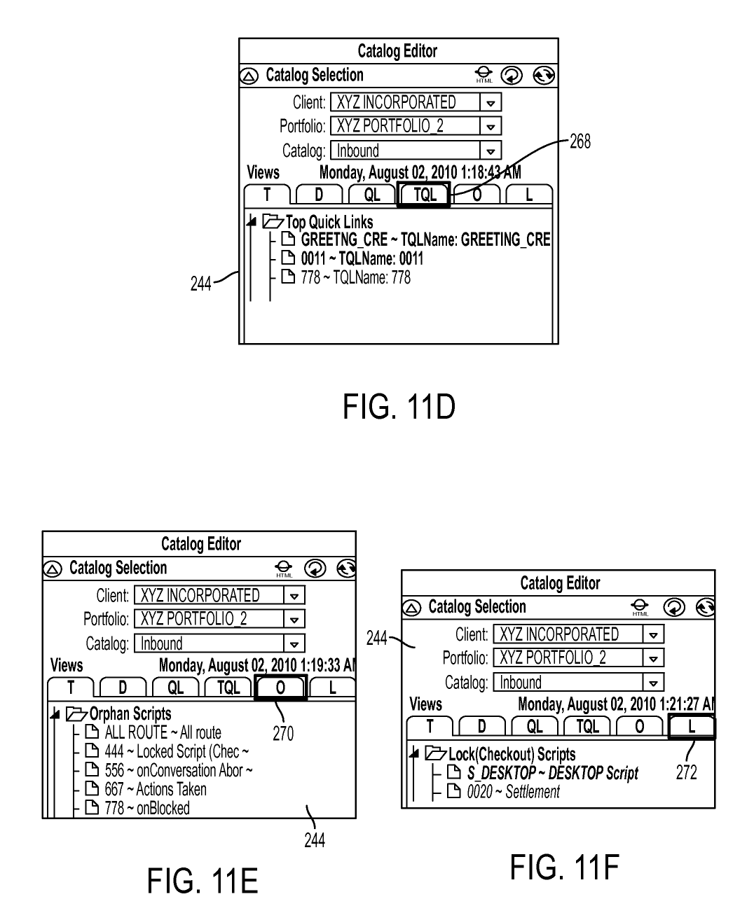

In pallet 234 (FIG. 9), various tabs are available for the user to change the tree presentation of the scripts in the catalog management pane 244. Referring to FIGS. 11A-11F, a tree tab (T) 256 is shown where the catalog base folder is not expanded 258a and expanded 258b. In the expanded mode, various nodes 260 are shown where a node exists for each script contained in the catalog base folder. A distinct scripts view (D) tab 262 lists distinct and individual scripts in the catalog. A search script box 264 allows the user to enter all or part of a script name and search the catalog for scripts. A left quick links scripts view (QL) tab 266 links to scripts and assists in easy navigation of select scripts that have been quick linked. A top quick links scripts view (TQL) tab 268 provides a listing of the top scripts used by a user. An orphan scripts view (O) tab 270 provides a listing of all orphan scripts contained in a catalog. An orphan script appears directly under a catalog but is not part of the main script tree. Finally, a lock (checkout) scripts view (L) tab 272 provides a listing of all scripts in the catalog that are locked. This allows the administrator to quickly determine which scripts are being modified or checked out.

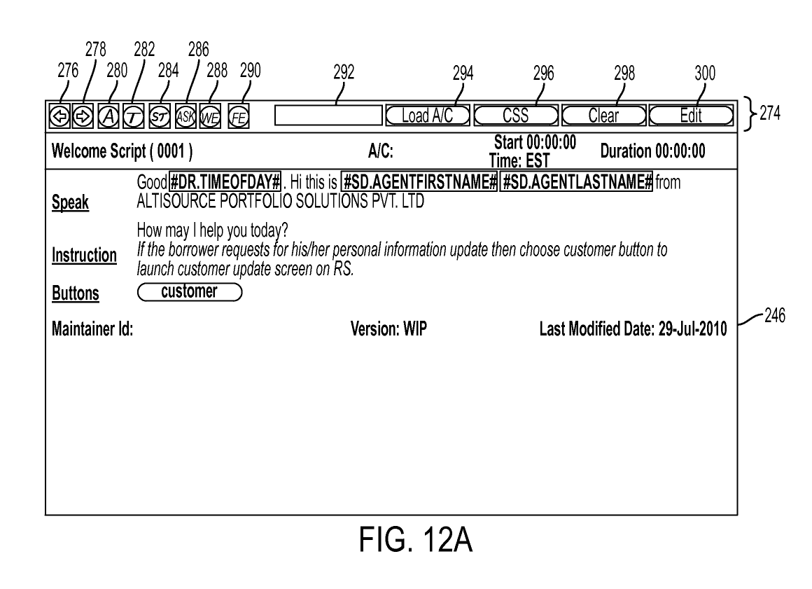

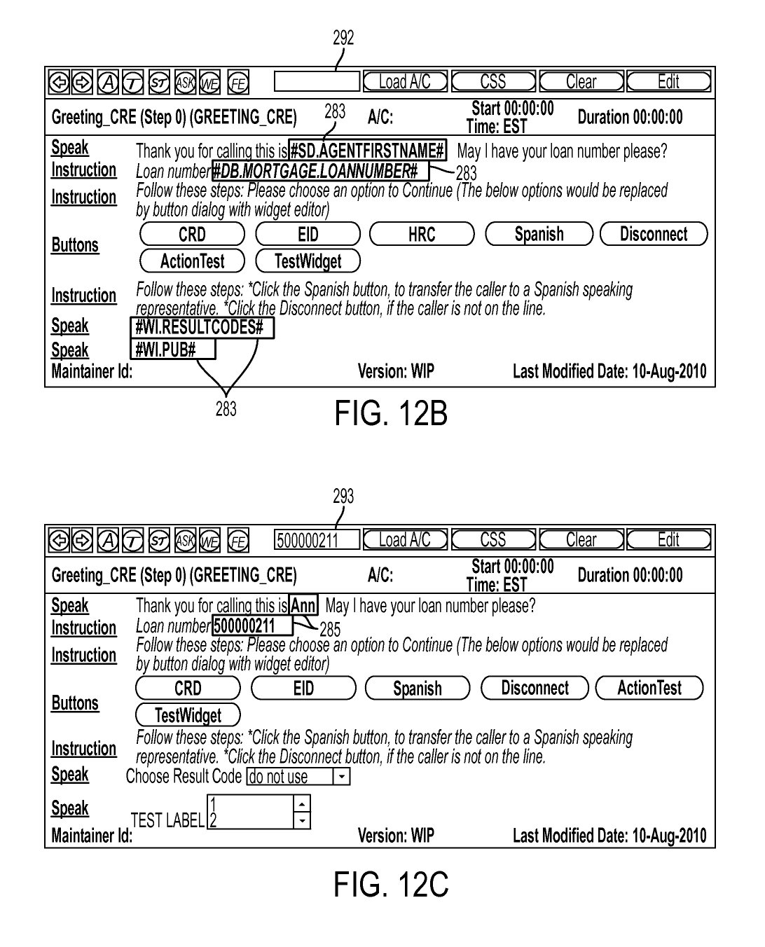

Referring to FIGS. 12A-12C, script testing window 246 is illustrated having a quick link bar 274. Scripts from a catalog can be tested in script testing window 246 to identify flaws in the flow, dialogs and links. The script testing window also allows the administrator to make variations to the script. Routing information can be checked to the same script, the same catalog or to another catalog. Function and widget routing can also be tested through the script testing window. Quick link bar 274 has a previous script button 276, a next script button 278, a show/hide actions button 280, a show tokens and value button 282, a show script tokens value 284, an open ask window button 286, an open widget editor window button 288, an open function editor button 290, an account number field 292 to enter a loan number, a load account number button 294, a launch scripting user interface button 296, a clear search box and data token values 298 and an edit script button 300.

Referring to FIGS. 12A-12B, to preview and test a script, the administrator would click on a particular script listed in catalog management pane 244 (FIG. 11A-11F) thereby listing the contents of the script in script testing window 246 including tokens 283. By clicking one of previous script button 276 or next script button 278, the administrator can view the previous or next script listed in the catalog management pane. The show/hide actions button 280 allows the administrator to enable or disable the request to post the data to the business parent system 106. Once a script is loaded, pressing show tokens and values button 282 allows the administrator to view all tokens that are available for a particular customer ID number. Show scripts token button 284 allows the administrator to view all tokens and their values in the loaded script. Ask button 286 allows the administrator to search for a script using a key word and view the searched script's path. The widget editor button 288 allows the administrator to launch the widget editor module. Function editor button 290 allows the administrator to launch a function editor module.

Referring to FIGS. 12A through 12C, account number field 292 allows the administrator to enter a real customer account number 293 so that the script can be viewed using real customer account information and token data values 285. Once a customer account number is entered, the administrator clicks on load account number button 294, which causes the scripting system to obtain account details from the various business systems and replace data tokens in the script with the appropriate token values 285. If no data tokens for the searched customer account number exist, a message (not shown) is displayed to alert the administrator. Clear button 298 allows the administrator to clear the account number value and associated token data values from the tested script. Finally, edit button 300 allows the administrator to edit the loaded script.

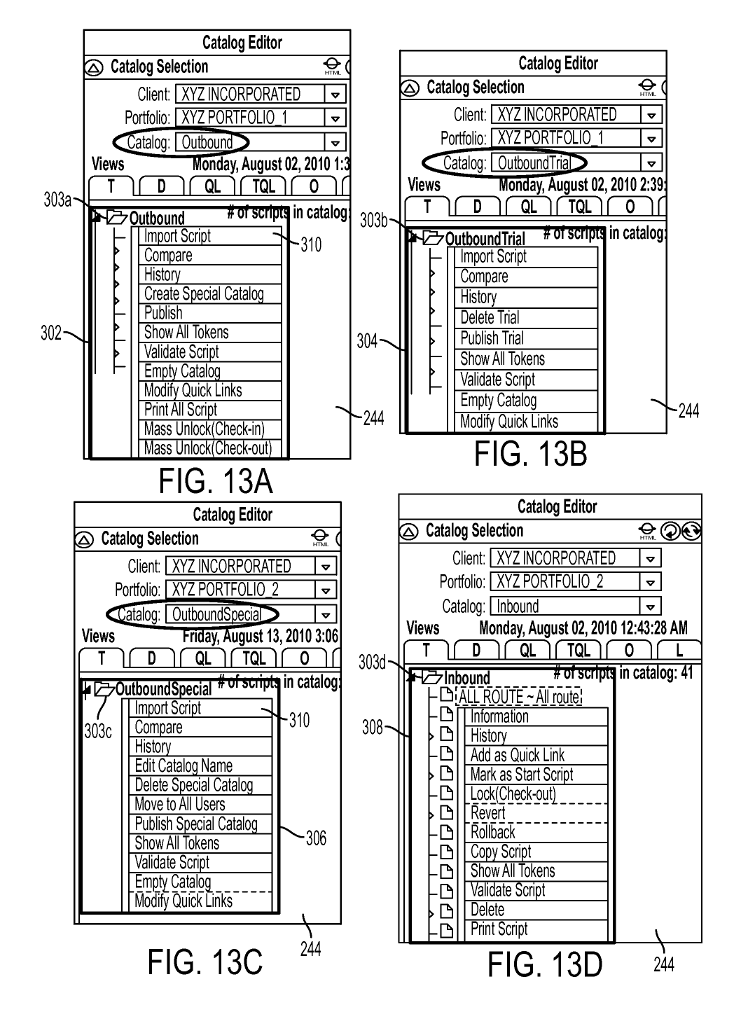

Referring to FIGS. 13A-13C, menu options 302, 304 and 306 are shown for managing outbound catalog 303a, outbound trial catalog 303b and outbound special catalog 303c. Moreover, referring to FIG. 13D, menu options 308 for managing the inbound scripts 303d are illustrated. To view any of these menu options, the administrator would right click on one of base folders 303a -303d to display one of menu options 302, 304, 306 and 308.

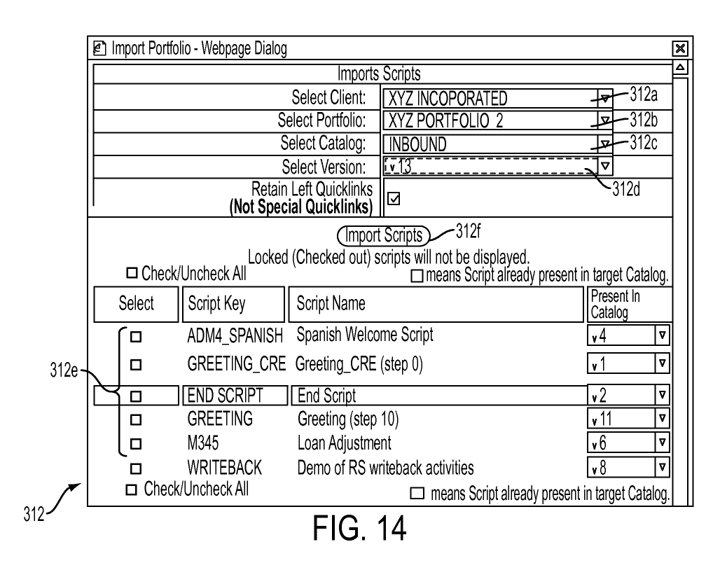

In managing a catalog, various menu options are available to the administrator. For example, the administrator may choose to import a script from an external catalog. When the import script option 310 (FIGS. 13A and 13C) is selected, an import window 312 (FIG. 14) opens to allow the user to select the client 312a, the portfolio 312b, the catalog 312c and the script version 312d. Once the above information is selected, then all scripts 312e for the selected catalog will be displayed so that the administrator can select one or more of the scripts in the catalog to import. Once the administrator selects the scripts to be imported, an import scripts button 312f is clicked to import the selected scripts into the catalog. If an imported script already exists in the catalog, the script being imported will overwrite and replace the existing script provided the script keys are identical.

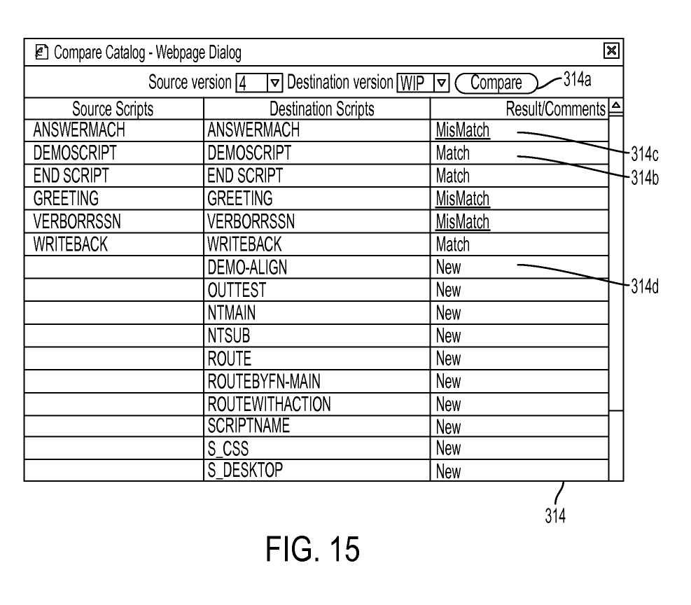

Referring to FIG. 15, the administrator may also choose the compare options (FIGS. 13A-13C) to compare source catalog scripts to destination catalog scripts prior to publishing the scripts. The compare option provides the administrator with a listing of variations between the source catalog scripts and the destination catalog scripts. Once the compare option is selected, a compare catalog window 314 opens. Once the source version and destination version have been selected, the user clicks compare button 314a. A comparison between the selected script versions is automatically run and the results of the comparison are displayed in a results/comments column which indicates whether the script versions are a match 314b, a mismatch 314c or if the script is new 314d.

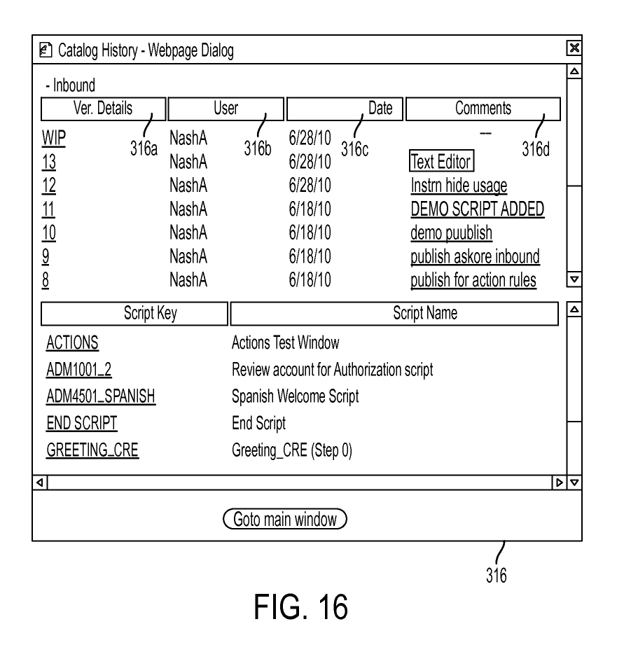

Referring to FIG. 16, a history menu option (FIGS. 13A-13C) allows the administrator to view the history of a catalog. When the administrator clicks on the history menu option, a catalog history window 316 opens to display historical information associated with a selected catalog, including each modification made to the catalog, and the details of each modification, including, previous version details, user name, the date of the modification and comments regarding the modification.

A publish menu option (FIG. 13A) is used to publish the catalog so all users may utilize the scripts in the catalog during customer interaction. Publishing a trial or special catalog publishes the trial or special catalogs to a select group of users assigned to test the scripts in those catalogs.

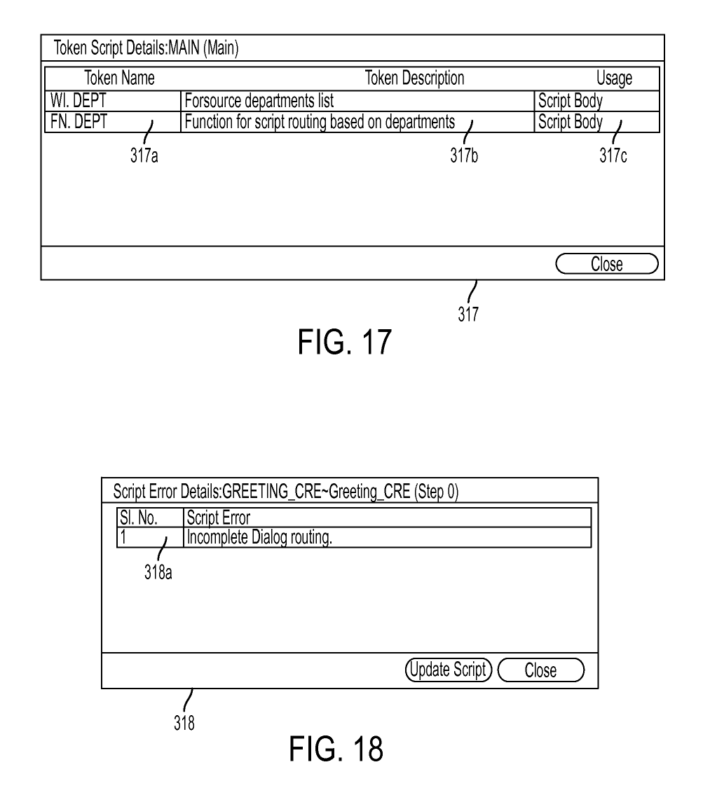

Referring to FIG. 17, a show all tokens option (FIGS. 13A-13D) opens a show all tokens window 317. The show all tokens window displays a listing of all tokens used in a script, including the token name 317a, the token description 317b and the token usage 317c.

Referring to FIG. 18, a validate script menu option (FIGS. 13A-13D) allows the user to validate a selected script. When the validate script option is selected, if the script is error free, a message (not shown) stating “There is no error in the script” appears. If, on the other hand, the script contains errors, a script error detail window 318 opens and displays at least one script error 318a.

Various other catalog options are available such as mass lock (check-out) and mass unlock (check-in) of scripts, print all scripts in a catalog, modify quick links for a catalog, empty a catalog, edit catalog name, etc., that provide various other functionalities to the administrator. Referring to FIG. 13D, in addition to catalog specific options, there are a variety of options that are available with respect to scripts contained in the catalog. As with the catalog options menu, to access the script options menu, the administrator would position the mouse over the script of interest and right click the mouse to open the options menu.

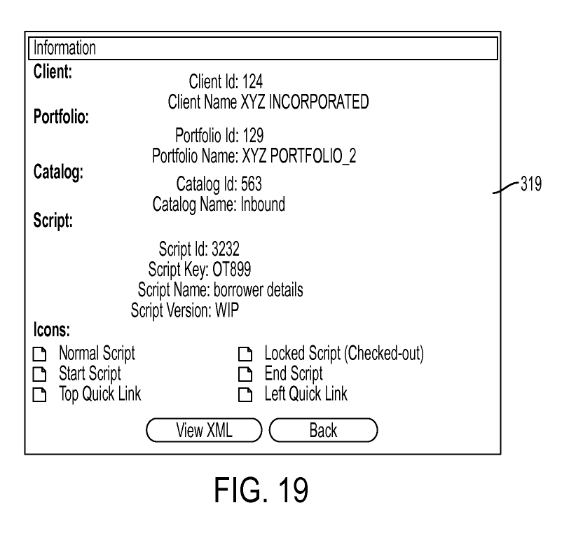

Referring to FIG. 19, a script information menu option (FIG. 13D), when selected for a particular script, opens a script information window 319. The script information window provides client, portfolio and catalog information regarding the script. Moreover, script details and an icon listing are provided to identify the script and the status of the script.

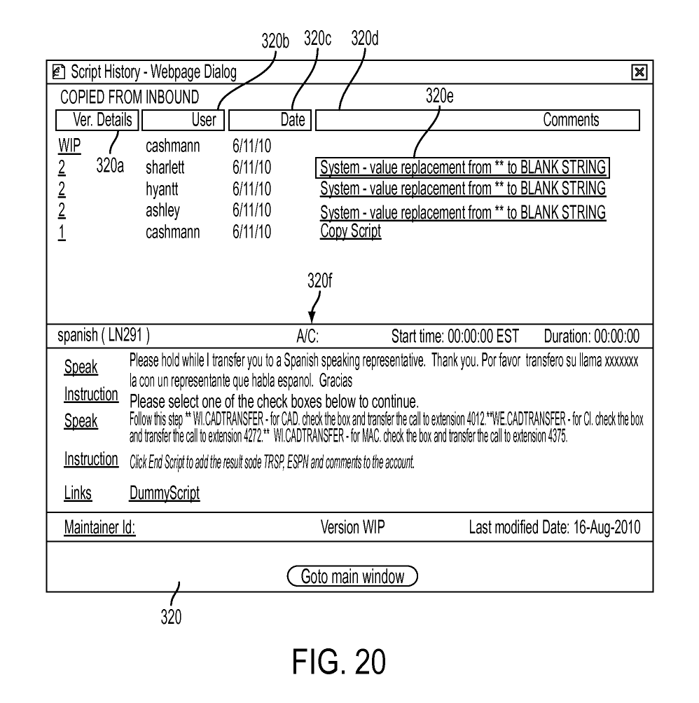

Referring to FIG. 20, a script history menu option (FIG. 13D) provides the administrator with a view of the script history. When the script history menu option is selected, a script history window 320 opens. Script history window 320 provides a listing of the script version details 320a, a user name associated with the version change 320b, a date of the version change 320c, and comments related to the change made 320d. When a specific comment 320e is selected, the details of the change 320f are presented.

Referring to FIG. 13D, additional script menu options include a quick link option that allows the administrator to add the selected script as a quick link, a remove quick link option, a menu option that allows the administrator to mark a script as the start script and a lock check-out option to lock a script, so it can be edited. The lock check-out option prevents other administrators from editing a script while it is currently being edited by another administrator. A revert menu option enables the administrator to go back to a previously checked-in version of a script. However, this option is only available if the script is checked out. A rollback menu option enables the administrator to go back to a previously published version of the script. A copy script menu option enables the administrator to copy a script, and a show all tokens menu item functions similar to the show all tokens menu option described with respect to FIG. 17. Similarly, a validate script menu option is available that functions similar to the script validation function described above with respect to FIG. 18

### Script Editor Module

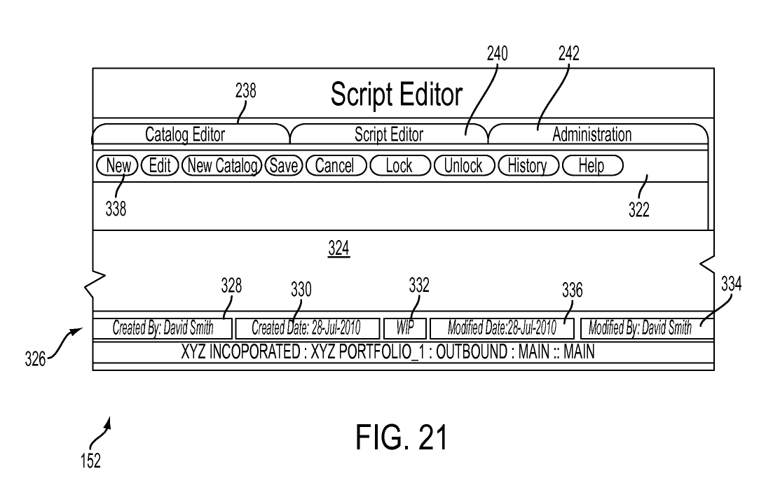

Referring to FIG. 21, when the script editor module 240 is selected, a script editing button pallet 322 is presented to the administrator. The script editor module provides a workspace 324 where new scripts can be created, old scripts are modified and redundant scripts can be deleted. Script editor workspace 324 also provides an area where scripts can be previewed before being published. A script footer 326 provides information regarding the script being created or edited, such as the name of the script creator 328, the date of creation 330, the current version 332, the name of the script modifier 334, and the date of modification 336. Script footer 326 also displays the name of the client, the portfolio, the catalog, the script key and the script.

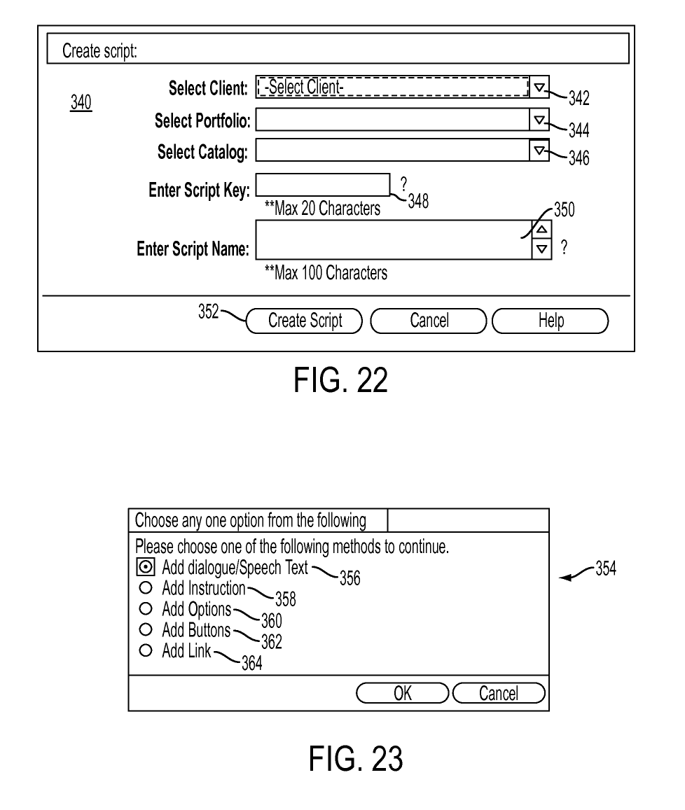

To create a new script, the administrator would click a new button 338 (FIG. 21) on the scripting editing pallet 322. Referring to FIG. 22, a create script window 340 opens allowing the administrator to select a client from drop down box 342. A client may have a number of portfolios and each portfolio can have an inbound and an outbound catalog. After selecting the client, the administrator selects a portfolio from drop down box 344 and a catalog from drop down box 346. Lastly, the administrator would enter a script key in field 348 and script name in field 350 to create a script. Once completed, a create script button 352 is clicked.

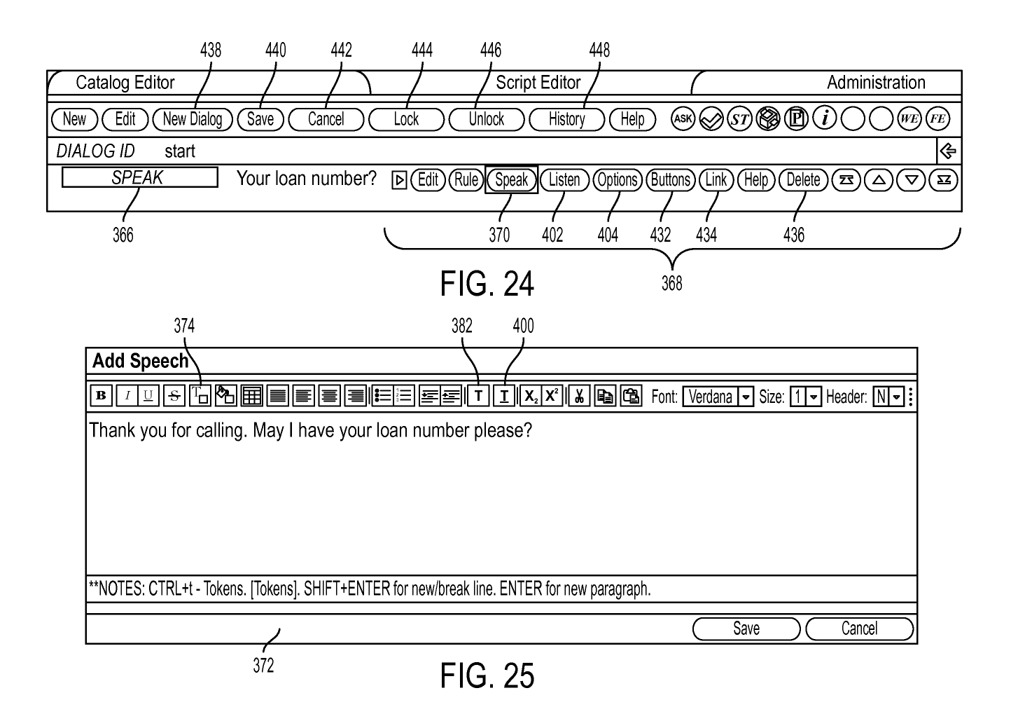

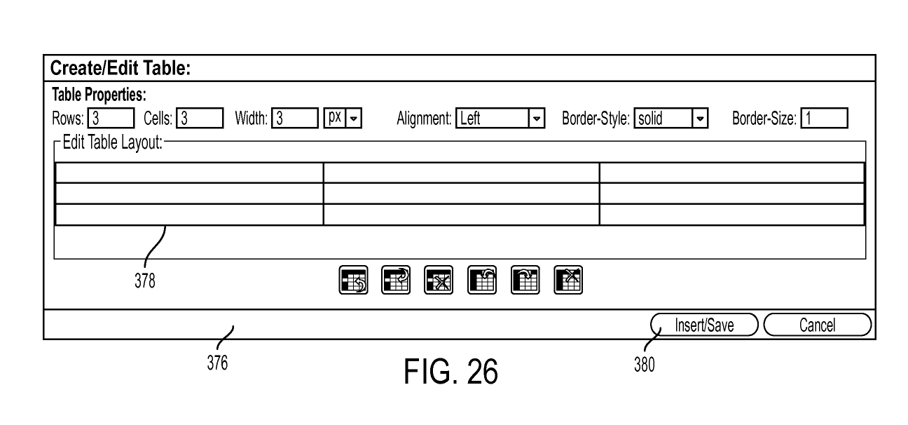

Referring to FIG. 23, once the create script button is clicked, an option window opens that allows the administrator to choose to add dialog/speech text 356, add instruction 358, add options 360, add buttons 362 or add a link 364. For example purposes, the add dialog/speech text option 356 has been selected. Referring to FIG. 24, a speak indicator 366 and a menu 368 is located in script editor module workspace 324 (FIG. 21). Referring to FIG. 25, when a speak button 370 (FIG. 24) is clicked, an add speech text editing window 372 opens so that the administrator can enter the speech. Add speech text editing window 372 contains various formatting buttons, thereby allowing the administrator to format the text. For example, if an insert table button 374 is clicked, a create/edit table window 376 (FIG. 26) opens to add a table 378. Once the table is formatted, an insert/save button 380 is clicked to insert the table into the text box.

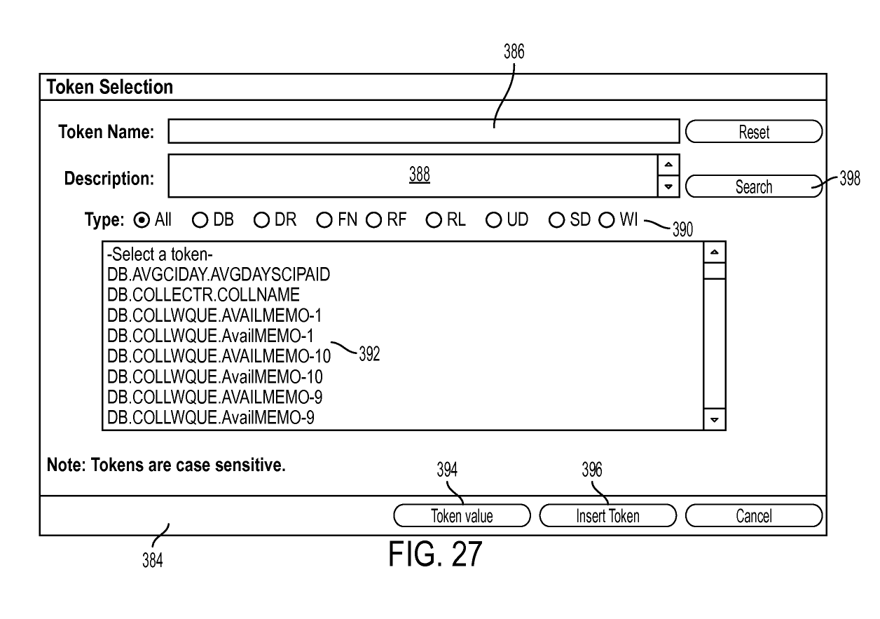

Referring to FIG. 27, the administrator can add tokens to the speech in add speech text editing window 372 by clicking add token button 382. Referring to FIG. 27, once add token button 382 is clicked a token selection window 384 opens. Token selection window 384 has a token name field 386, a description field 388, a token type field 390, a listing 392 of all available tokens, a token value button 394 and an insert token button 396. The administrator can search for a token by name or description by entering all or part of the token name token name field 386 and clicking search button 398. The administrator can also search for a token by entering all or part of the token description in token description field 388 and clicking search button 398. Token value button 394 is only applicable when the widget token type is selected from token type field 390.

It should be noted that various other functions can be used in add speech text editing window 372. For example, when a special instruction button 400 is clicked after selecting all or a portion of the text, the selected text color would change to indicate that the text is a special instruction. Similar to speak button 370 (FIG. 24), an instruction button 402 allows the administrator to add an instruction line to the script. When instruction button 402 is clicked, an add instruction screen (not shown) opens that allows the administrator to add text for the instruction.

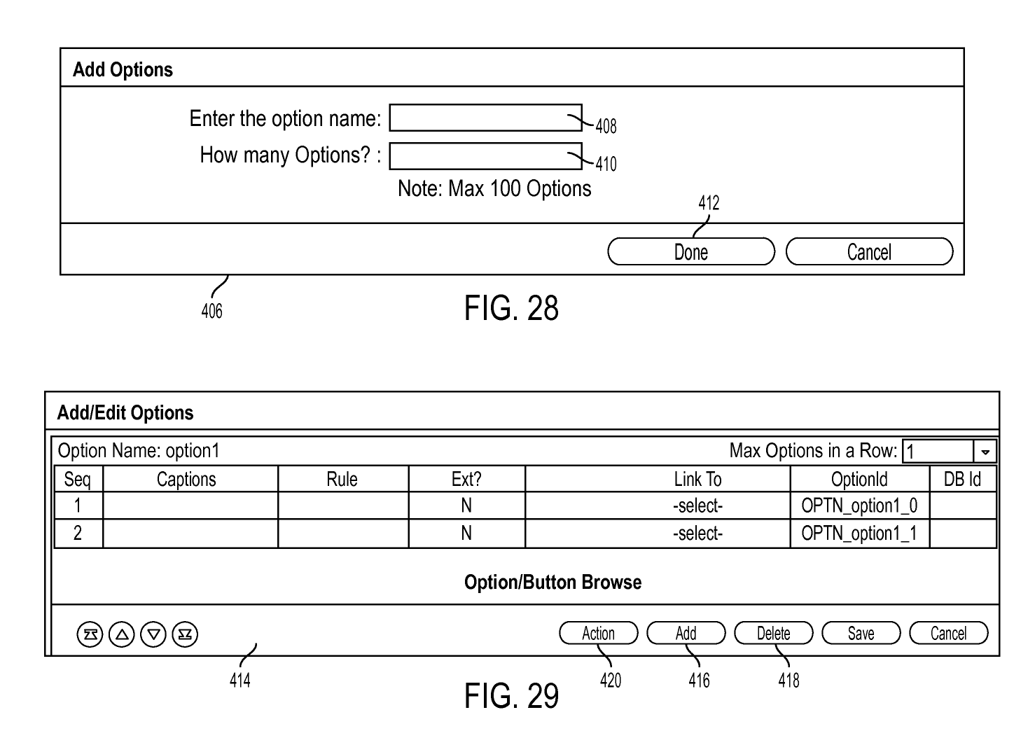

As part of the script, the administrator can also add options by clicking options button 404 (FIG. 24), which will then be available for the user to select as part of the logical choices presented to the customer. Referring to FIG. 28 an add options window 406 opens that allows the user to type in an option name 408 and the number of options 410 that are to be added. Referring to FIG. 29, once a done button 412 (FIG. 28) is pressed, an add/edit options screen 414 opens. Add/edit options screen 414 allows the administrator to add additional options by clicking an add button 416, delete options by clicking a delete button 418 and define the action of an option by clicking an action button 420.

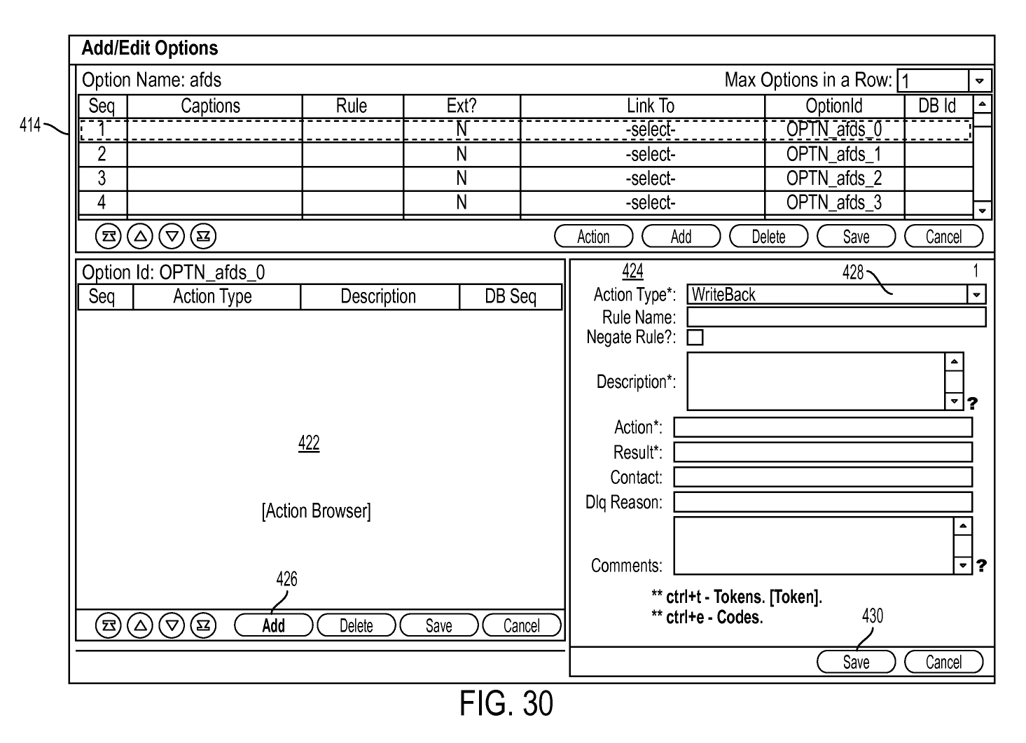

Referring to FIG. 30, when an option is selected and action button 420 (FIG. 29) is pressed, add/edit action window 414 expands to include an action browser 422 and an action window 424. By pressing an add button 426 the administrator can select one of the available action type options from dropdown menu 428. In one preferred embodiment, the administrator may select from one of a write back action, an end script action, a parent button action, an external action and a business system action. If for example, the administrator selects the write back option from dropdown menu 428, additional fields are made available in action window 424. Each of the various actions from dropdown menu 428 may present additional fields that are specific to the selected action. Once the action has been defined for the selected option, the administrator clicks a save button 430 to save that action for the selected option.

Referring again to FIG. 24, similar to the add option feature, an add button 432 and add link button 434 feature is available to add button choices and hard links to the script. As previously indicated, buttons are used to route a script within or outside of the catalog and links are connections to other scripts or options. Moreover, a delete button 436 allows the administrator to delete an element of a script by highlighting the element and clicking delete button 436.

Furthermore, new dialog can be added to the script by clicking a new dialog button 438. The process for adding new dialog includes the ability to add dialog/speech, instructions, options, buttons and links. Once all changes are made to a script, the save button 440 is clicked to save the script to the system. A cancel button 442 will cancel all current changes to a script through the last save point of the script.

A lock button 444 allows the administrator to lock the script to prevent others from editing the script while the administrator is in the process of editing. An unlock button 446 allows an administrator to unlock a script once editing is complete and a history button 448 allows the administrator to view information relating to the creation of a script and its subsequent modifications. Other additional features available to the administrator are a validation script icon (not numbered) and a show all tokens icon (not numbered) that function similar to the features described with respect to the catalog editor of FIGS. 13A-13D, a printable script icon (not numbered) that allows for printing of the script and a preview icon (not numbered) that allows the administrator to view the outcome of the script addition or modification without having to save the changes to the system.

When a script is added or modified, a version management system attaches an incremental version number to the script. When a script is being edited it does not have a direct relation to the version that is being used in production. Once a new or modified script is published for use in the production environment, the published script is backed up and a copy of it is made available to the administrator to edit or modify. Thus, unintended changes to the script that may affect end users are prevented from the production version of the script.

### Administration Module

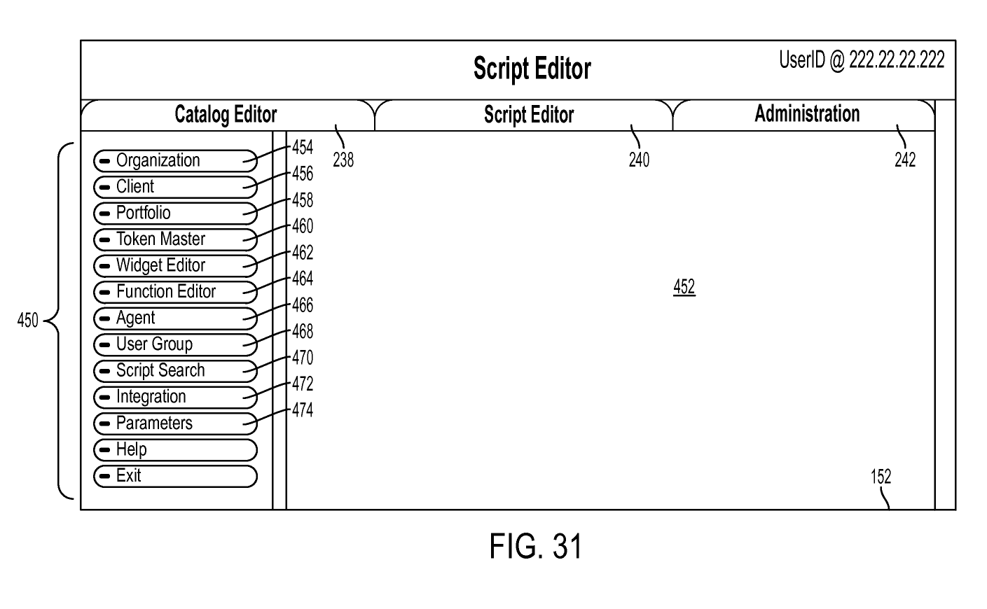

Referring to FIG. 31, script editor interface 152 contains administration utility tab 242, which may be accessible to all administrators or selected administrators as determined by the system requirements. Administration utility tab 242 contains a menu 450 and a workspace 452. Menu 450 contains multiple option buttons that provide various features for administration and management of clients and assets in scripting system 104 (FIG. 3). An organization menu button 454 allows for the addition, modification and deletion of organizations. A client menu button 456 allows for the addition, modification and deletion of clients. A portfolio menu button 458 allows for the addition, modification and deletion of portfolios. A token master menu button 460 allows for the selection of tokens and storage of client details pertaining to each token. A widget editor menu button 462 allows for the creation of widgets for a script that can be used throughout a conversation. A function editor menu button 464 allows for the creation of custom functions that are evaluated for values at token pre-fetch time. An agent menu button 466 allows for the addition, modification and deletion of users of scripting system 104. A user group menu button 468 allows for the addition, modification and deletion of user groups. A script search menu button 470 allows for the search and download of scripts. An integration menu button 472 allows for the control and launch of script interface window 142 (FIG. 4A). Finally, a parameters menu button 474 allows for the addition and modification of system level parameters that are set up to provide system level information.

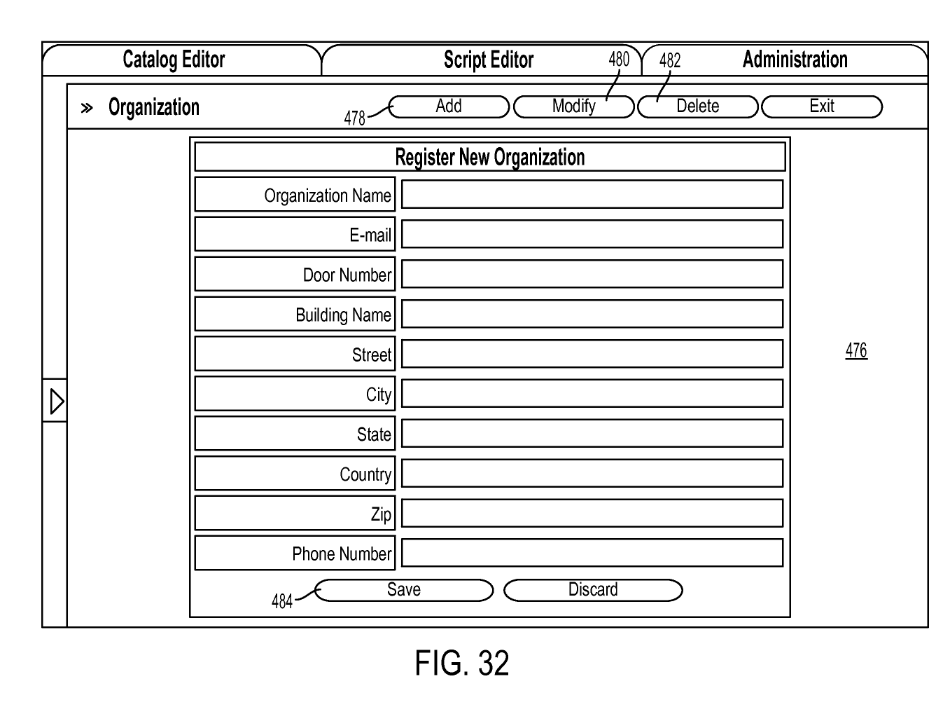

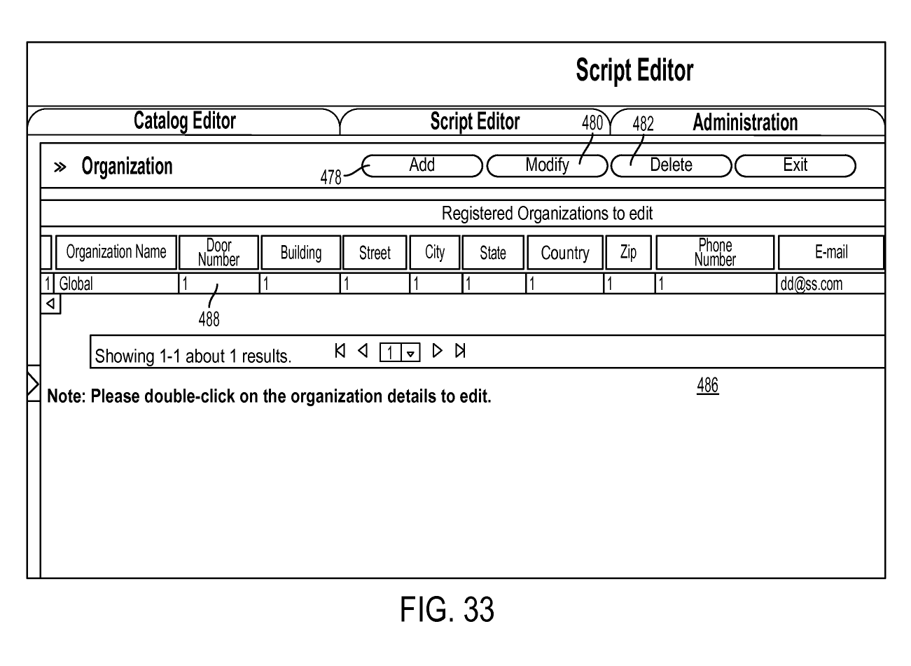

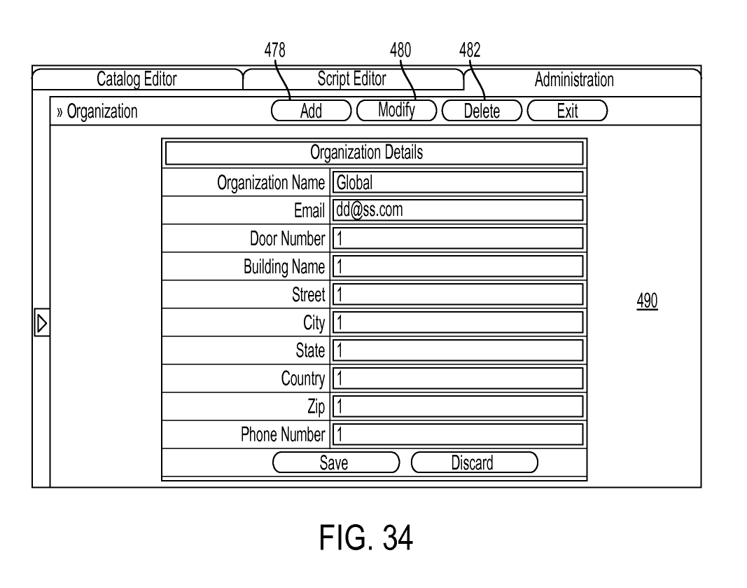

Referring to FIG. 32, by clicking the organization button 454 (FIG. 31) an organization screen opens (not numbered) and provides the administrator with a choice to add 478, modify 480 or delete 482 an organization. By clicking add 478, a register new organization screen 476 opens to allow the administrator to enter organization details for the organization being added to the system. Once the new organization details are entered, the administrator clicks a save button 484 to save the new organization to the scripting system 104. Referring to FIG. 33, when modify 480 is chosen, a modify organization screen 486 opens to allow the administrator to select an organization to be modified. By double clicking on an organization 488, an organization detail screen 490 (FIG. 34) opens to allow the administrator to make necessary changes. Referring again to FIG. 32, delete 482 operates similar to that of modify 480 in that a delete organization screen (not shown) opens providing a listing of the organizations stored in the system. The administrator would then select the organization that they wish to delete and then click on a delete button (not shown). It should be noted that client button 456 (FIG. 31) provides similar functionality as the organization menu button in that you can add, modify and delete clients similar to that with organizations. Thus, for the sake of brevity, the description with respect to the client menu button will not be discussed in detail.

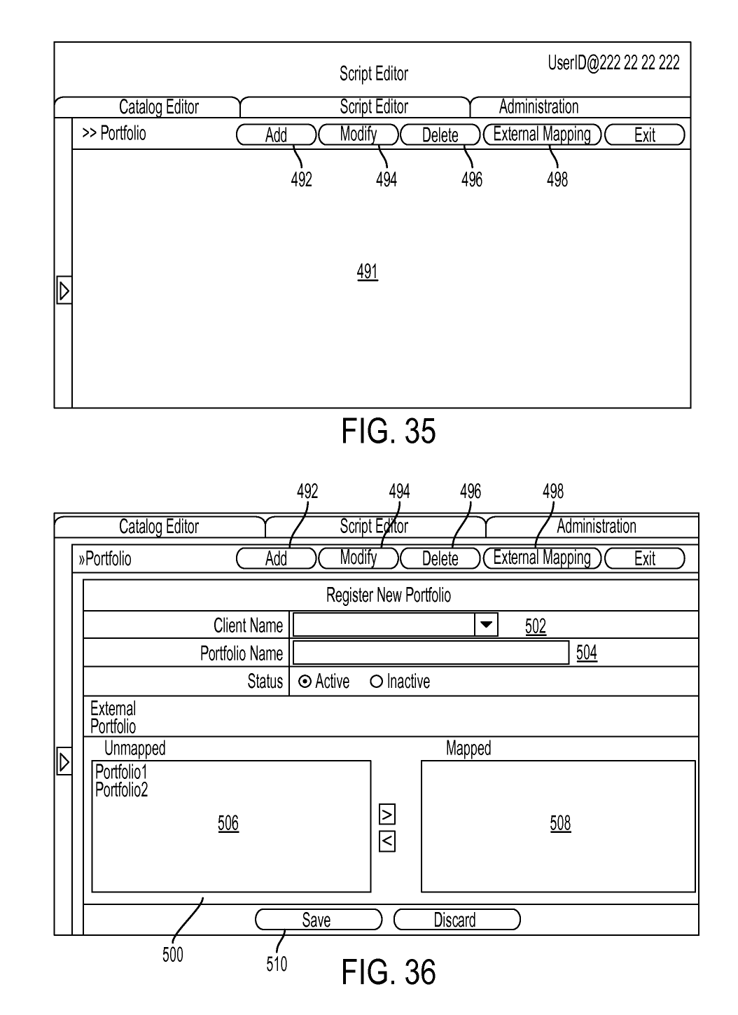

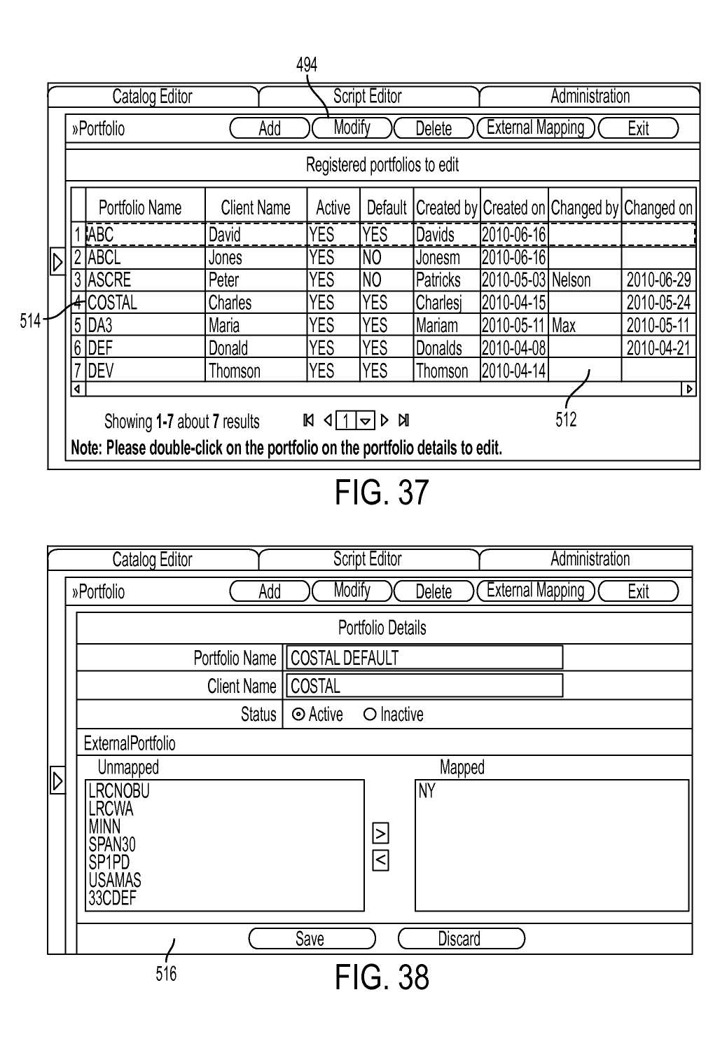

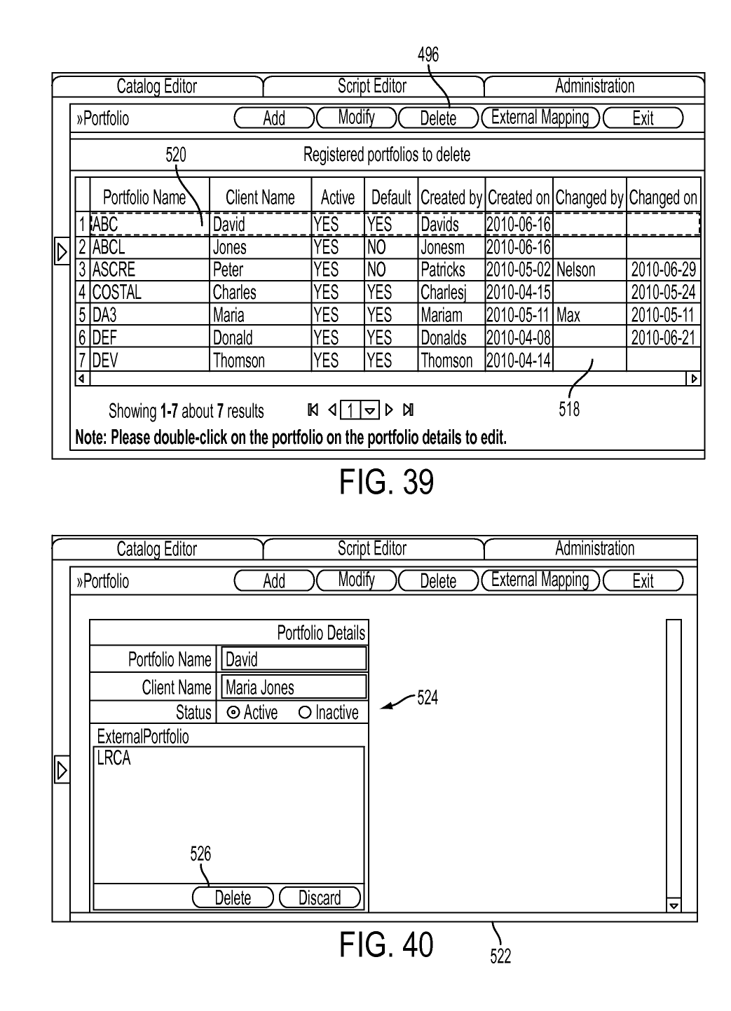

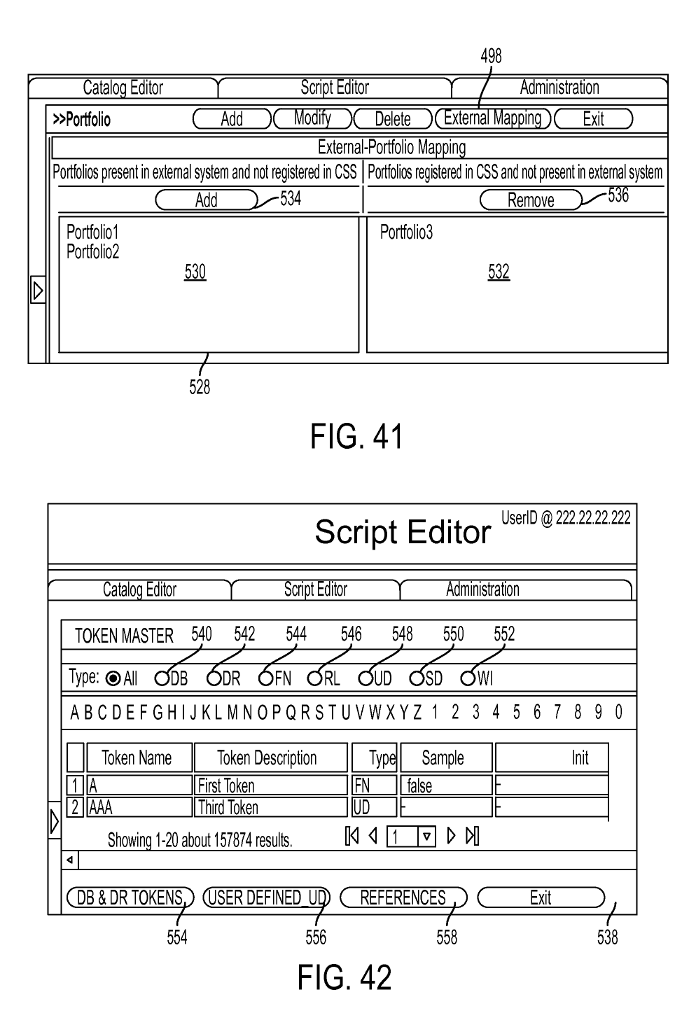

Referring to FIG. 35, by selecting portfolio button 458 (FIG. 31), a portfolio screen 491 opens and allows the administrator to add 492, modify 494, delete 496 and or retrieve a portfolio from an external system by using an external mapping selection 498. Referring to FIG. 36, by selecting add 492, a register new portfolio screen 500 opens. The administrator may select a client name 502 and enter a portfolio name 504. The administrator then selects one or more portfolios from an unmapped listing 506 and moves them to a mapped listing 508. The new portfolio is registered by clicking a save button 510. Referring to FIG. 37, a portfolio may be modified by clicking modify 494, which opens a listing 512 of all portfolios in the system. By double clicking a particular portfolio 514, the portfolio details window 516 (FIG. 38) opens allowing the user to change the portfolio name, client name, status or whether the external portfolios are mapped or unmapped. Referring to FIG. 39, a portfolio may be deleted by clicking delete 496, which opens a listing 518 of all registered portfolios that may be deleted. By selecting a portfolio 520, a delete portfolio window 522 (FIG. 40) opens that provides portfolio details 524. The displayed portfolio can be deleted by clicking delete button 526. Finally, referring to FIG. 41, by clicking external mapping 498 (FIG. 35), an external-portfolio mapping window 528 opens and displays in a first section 530 portfolios that are not registered in the scripting system 104, but are present in the external business parent system 106 and in a second section 532 those that are registered in the scripting system, but not present in the external system. A portfolio in can be added or removed from scripting system 104 by selecting the portfolio and clicking on the corresponding add or remove buttons 534 and 536, respectively.

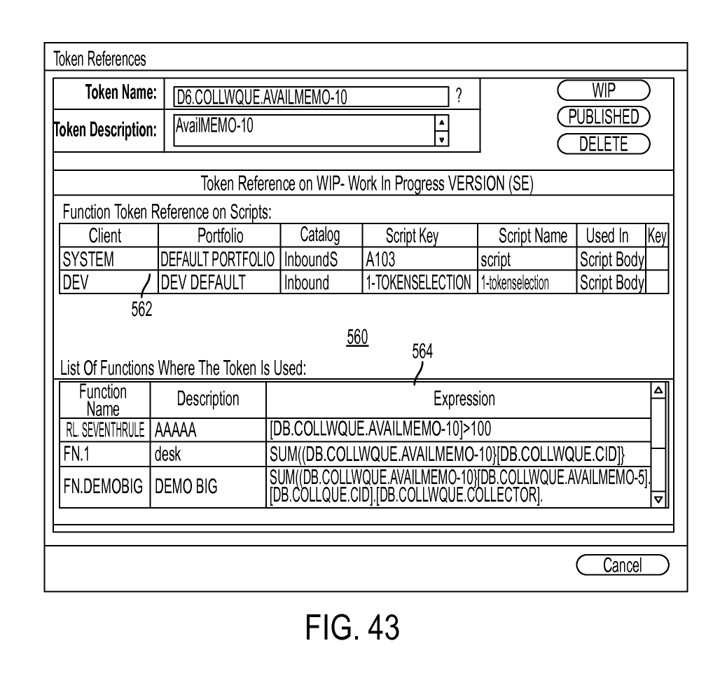

Referring to FIG. 42, when token master button 460 (FIG. 31) is selected a token master screen 538 opens that displays all the tokens used in scripting system 104, such as database (DB) tokens 540, user defined (UD) tokens 548, system defined (SD) tokens 550, derived (DR) tokens 542, widget (WI) tokens 552, function (FN) tokens 544, and rules (RL) tokens 546. In token master interface 538, the administrator can view tokens used for a specific script. Referring to FIG. 43, by selecting a DB & DR tokens button 554, an add tokens screen (not shown) opens to allow tokens to be added. To modify any token, the administrator would double click on a selected token to get to an edit token screen (not shown) where the token details may be modified. The administrator can also define tokens, that is, user defined (UD) tokens in which specific client details such as company name, company address and so on can be stored by clicking UD button 556. Finally and referring to FIG. 43, by clicking references button 558 (FIG. 42), all details about a specific token can be viewed in a token reference screen 560. Token reference screen 560 provides detailed information 562 about the tokens, including, but not limited to, the client and portfolio they are associated with, the catalog in which they reside. Also within token reference screen 560 is a list of functions 564 where the tokens are used. From token reference screen 560, the administrator can delete and view the publication status and work-in-progress status of the token.

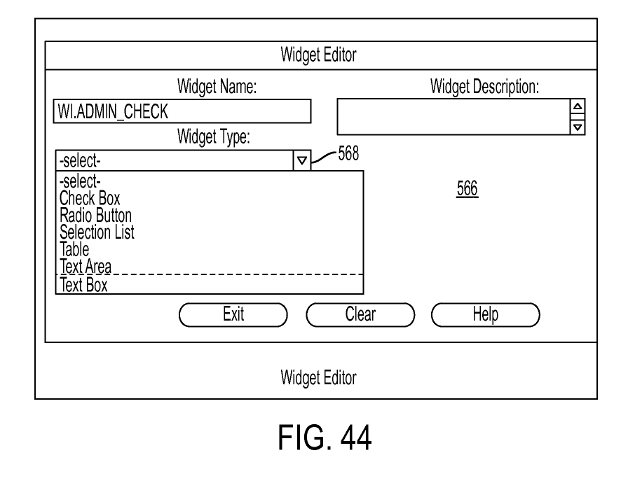

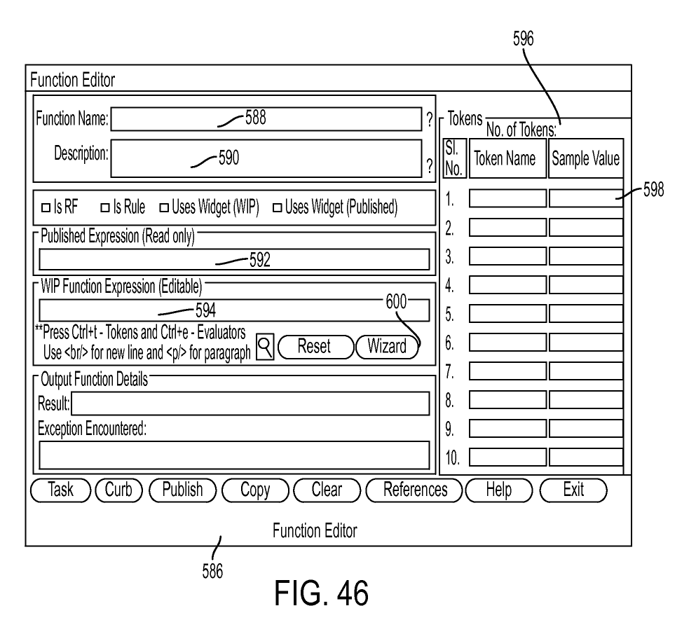

Referring to FIG. 44, when widget editor button 462 (FIG. 31) is selected a widget editor screen 566 opens to allow the administrator to name a widget, create a widget description and to select the type of widget from a widget type drop down menu 568. Widget editor 566 provides the functionality to accept user entered values into scripts and use them throughout a conversation. User entered values need to be loaded onto the function editor 586 (FIG. 46) to be used in other scripts within scripting system 104. A widget by definition is a graphical representation of a value. Once a widget is defined, it is used similar to a token in scripts and functions. The administrator can attach rules to a widget. Some examples of pre-defined rules are: (1) allow only non-blank values, (2) values entered should be numeric, (3) values entered should be characters, (4) special characters are not allowed and (5) date entered should be greater than the current date. When an inbound/outbound call reaches the user, the values for the widget token used are entered. The scripting system validates these values against the rules set by the administrator while defining a widget. If the rules are satisfied, the normal process is continued. If the rules are not satisfied, then the user is alerted to enter appropriate values. The administrator controls certain graphical features of the widget and can publish widgets on a standalone basis or as a part of catalog publishing activity. In the case of standalone publishing, all scripts using the token as a widget are affected. If a widget is changed and published, it affects all versions of the scripts under all clients, portfolio and catalog combination.

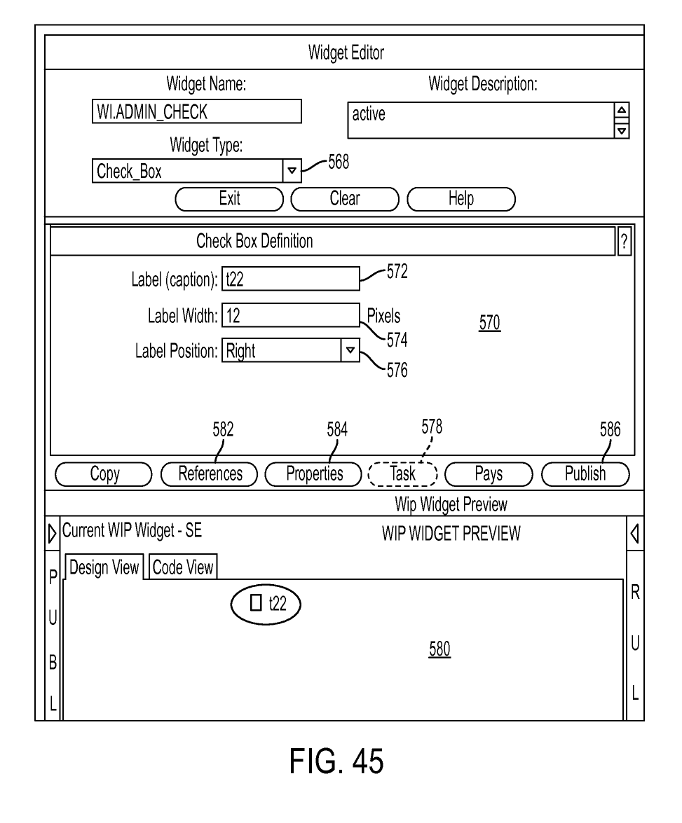

Referring to FIG. 45, the administrator selects the widget type 568 to create a widget.

For example purposes, the creation of a check box widget is shown. Once the check box type is selected from widget type drop down menu 568, a check box definition section 570 is available to the administrator to further define the widget by entering a check box label caption 572, label width (pixels) 574 and label position 576. Once these values are entered, a test button 578 is selected to allow the widget to be viewed in a widget preview section 580. Once the widget is tested, the administrator can save and publish the widget. Other options include a references button 582 to view the widget token references, a properties button 584 to view the widget token properties and a publish button 586 to publish the widget token. It should be understood that similar steps are available to add radio buttons, tables etc. using the widget editor screen 566 (FIG. 44).

Referring to FIG. 46, selection of function editor button 464 (FIG. 31) causes a function editor screen 586 to open. Function editor screen 586 provides the ability to write custom functions. Functions are to be evaluated for values before beginning the customer contact and are used to derive additional data tokens for scripts from the initial data tokens of the business parent system. The ability to use all tokens and existing functions inside a new function as well as its interaction with versioning of scripts are some of the other features of function editor screen 586. Function editor screen 586 allows the administrator to enter a function name 588 and enter a description 590, view a published expression 592 and enter/edit a WIP function expression 594. The administrator can also view the number of tokens 596 and the sample value 598 against the selected function. By clicking a wizard button 600, a wizard screen 602 opens.

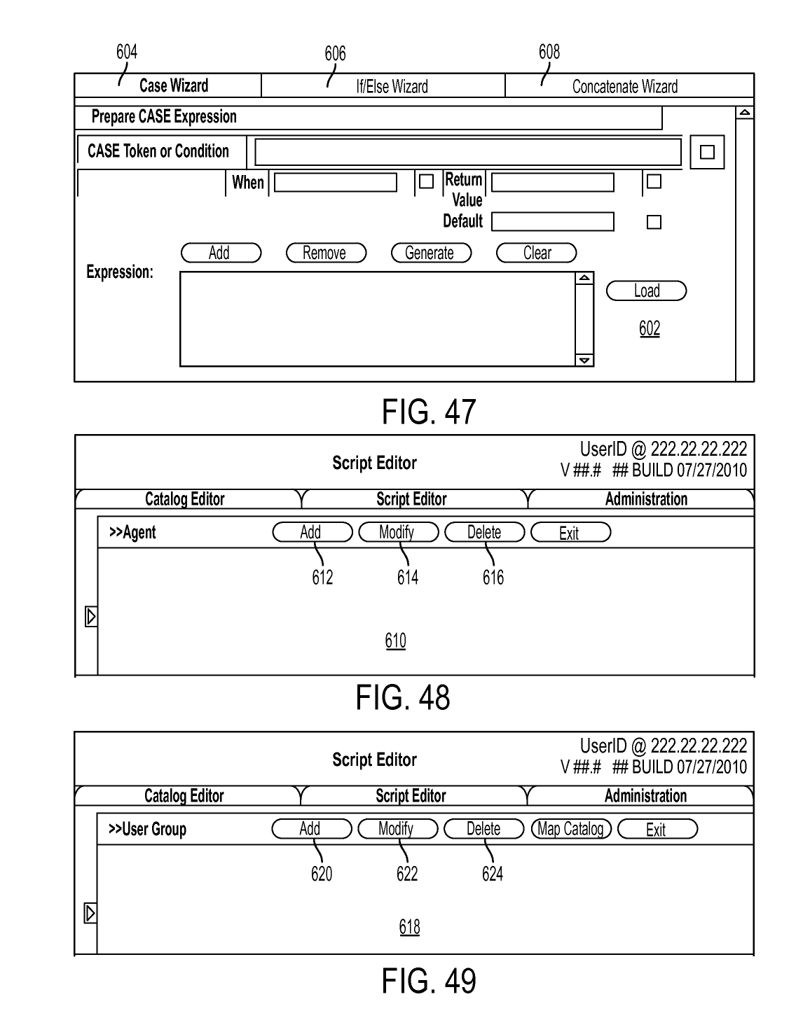

Referring to FIG. 47, wizard screen 602 provides three specific wizard tabs: a case wizard tab 604, an if/else wizard tab 606 and a concatenate wizard tab 608. A case expression returns a value when a certain condition is met. The condition is usually defined by a case token. An if/else expression allows the administrator to provide a result when a condition is met or a second result if the condition is not met. Finally, a concatenate expression is used to generate conditional listings of information.

Referring to FIG. 48, when agent button 466 (FIG. 31) is selected an agent window 610 opens. Agent window 610 allows the administrator to add 612, modify 614 and delete 616 agents that have access to scripting system 104. Moreover, referring to FIG. 49, when a user group button 468 (FIG. 31) is selected, a user group window 618 opens that allows the administrator to add 620, modify 622 and delete 624 user groups. Add 620 allows the administrator to create a new user group and add specific users from a list of available agents (not shown). Modify 622 allows the administrator to add and delete specific users from an established group. Delete 624 allows the administrator to delete established user groups.

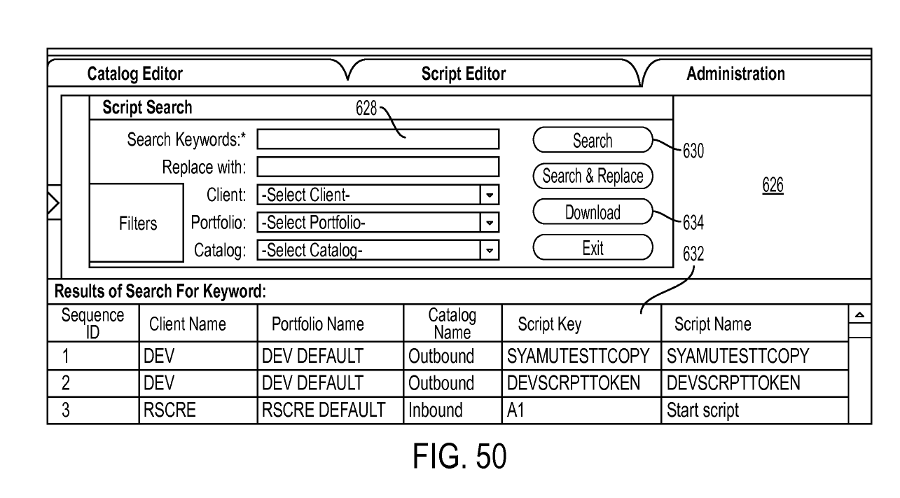

Referring to FIG. 50, when script search button 470 (FIG. 31) is selected, a script search window 626 opens and provides functionality for the administrator to search for scripts by entering a keywords in a keywords field 628. For example, if the word “default” is entered and a search button 630 is clicked, a list 632 of all scripts containing the word “default” will be returned. A download button 634 allows the search results to be downloaded into an excel file. In addition, various filtering options exist narrow the search criteria such as filtering by client, portfolio and/or catalog.

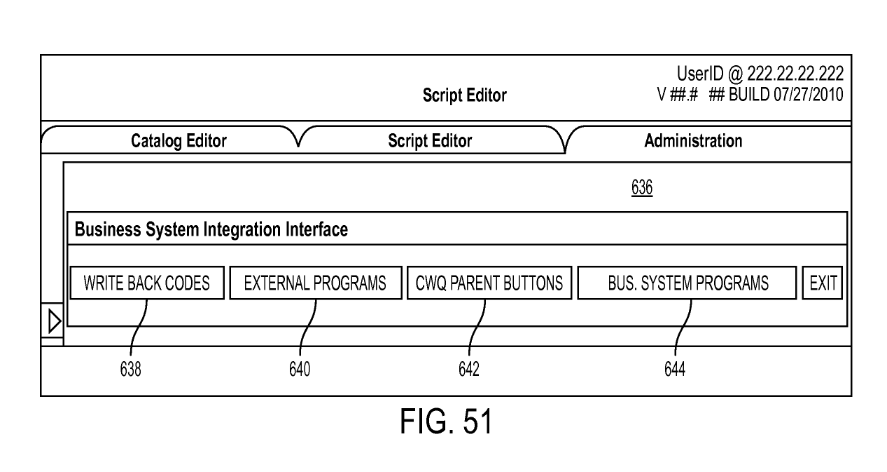

Referring to FIG. 51, when integration button 472 (FIG. 31) is selected, a business system integration interface 636 is opened. Business system integration interface 636 contains a write back codes tab 638, an external programs tab 640, a CWQ parent buttons tab 642 and a business system programs tab 644. Write back codes tab 638 provides a user interface to write comments or user actions with static text into one or more of business parent systems 106. External programs tab 640 provides a user interface for updating details of external programs. Examples of external programs include, but are not limited to, third-party analytics systems or data aggregators. CWQ parent tab 642 provides a user interface that allows for updates of button changes in the business parent system 106. That is, when a button is added into one or more of the business parent system interfaces, the scripting system will also be updated accordingly. The business system programs tab 644 functions similar to that of the external programs tab in that it provides a user interface that allows the administrator to update details relating to the one or more of the business parent systems 106.

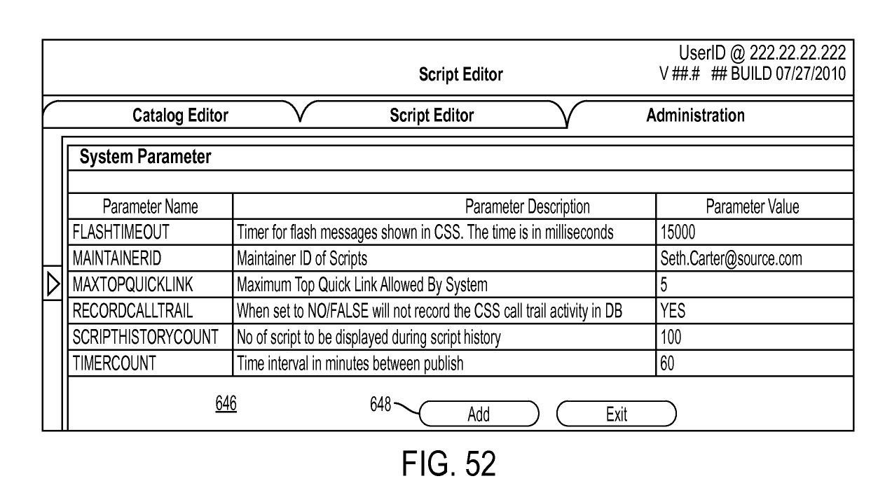

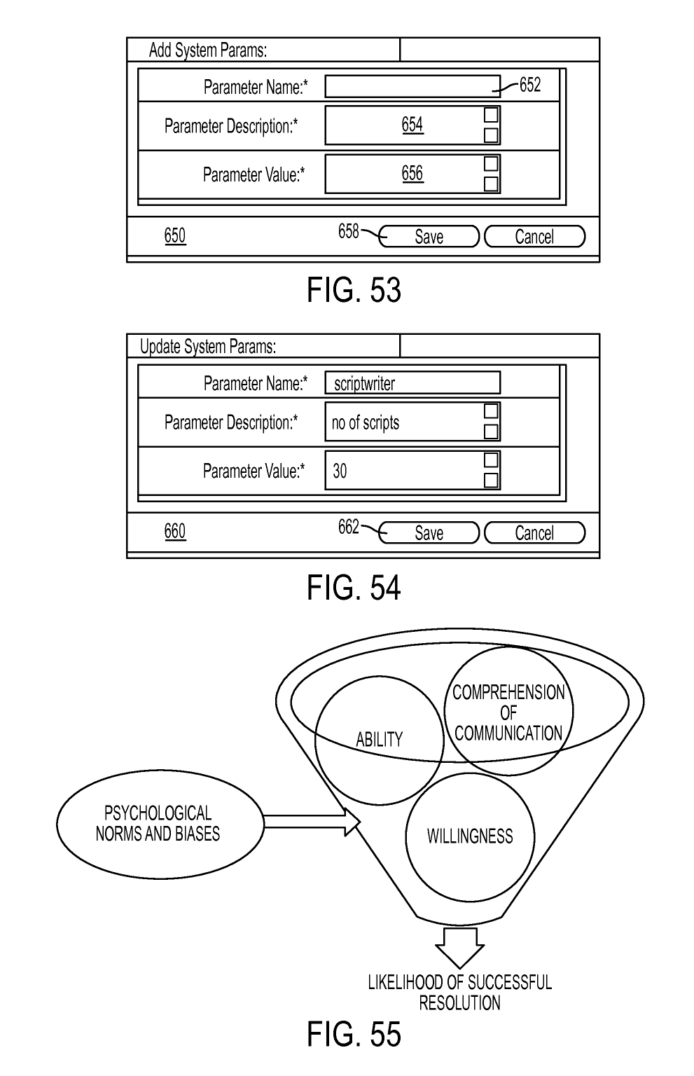

Finally and referring to FIG. 52, parameter button 474 (FIG. 31) when selected opens a system parameters user interface 646. As previously described, scripting system 104 provides a user interface to define write-back codes using XML into business parent systems 106. The business parent systems need to be assigned with a set of predefined input parameters. Thus, after tokens are selected for function expressions, the input function parameter details are populated with a number of parameters. System parameters user interface 646 allows the administrator to add and edit system parameters. Referring to FIG. 53, when an add button 648 (FIG. 52) is selected, an add system parameter screen 650 opens and allows information about the new parameter to be entered, such as the parameter name 652, the parameter description 654 and the parameter value 656. Once the values are entered, clicking a save button 658 saves the parameter details to the system. Referring once again to FIG. 52, to modify a parameter, the administrator double clicks on a selected parameter, which causes an update system parameters screen 660 (FIG. 54) to open. The administrator can edit the necessary parameter details and save the parameter by clicking a save button 662.

The above description with respect to FIGS. 1-54 are provided as one preferred embodiment of scripting system 104 to illustrate how the various features of the system allow the user/administrator to configure the scripting system without needing to recode and recompile the software. These features are exemplary and are not inclusive of all possible features of scripting system 104. One of skill in the art should understand that many additional features are possible based on the intended use of scripting system 104. As a result, scripting system 104 is a highly configurable and adaptable standalone system that allows business process workflow to be created for most any customer interaction.

### Behavioral Influence in Customer Communications

Research in the behavioral sciences has produced a vast and disparate body of knowledge that identifies techniques and methodologies for communicating with customers. It is generally difficult to utilize this knowledge in a setting that requires scale, though, because only practitioners who have a deep and broad understanding of the field can construct meaningful, systematic ways to deploy the techniques. This is because the techniques are rarely mapped explicitly to specific customer settings, so generalization is required. Further, because the techniques are often situational, working due to features of a particular state versus traits, using the techniques at the wrong time or in a slightly incorrect manner can often severely attenuate or reverse their effectiveness.

For these reasons, widespread attempts to direct behavior in a meaningful way using these proven techniques fall flat. Only specific interventions are deployed. For instance, a specific letter may be redesigned using some basis in psychological research, a website's navigation may be optimized but not its content, or a specific script may be written to address a single topic in a customer contact.

CMS system 100 allows for the widespread, systematic use of optimized communication through reliance on and deployment of research in the behavioral sciences. It does this through a dynamic pathways engine that can change content based on user interaction, predictive models, psychological research as well as best practices. Changes are carried out in real-time and without the customer or user's explicit knowledge as to the research theories, data sources or models.

Further, CMS 100 allows for the retrieval of multiple data sources, input of an infinite number of modeling components or user actions, and creation of workflow based on actions taken in the system. This allows end-users to navigate the system to create significant workflow events versus trying to access multiple screens to enter or retrieve data. The result is an intuitive system that minimizes cognitive load while maximizing communication effectiveness.

One of the central tenets of CMS 100 is that, though each customer may be different, a large number of psychological factors influence communication in systematic and predictable ways. These global factors shape customers' comprehension, ability and willingness to respond to a particular communication. Referring to FIG. 55, a graphic of proposed impact of psychological factors on customer communication is shown. The key is that, even though a customer may understand the message clearly and be willing and able to respond, the optimal message is delivered only by accounting for all of the psychological factors that can influence the customer's response at an individualized level. The biggest detriment to using these techniques is that they cannot be used en masse at any level of scale. Knowing the right time and place to use the concepts is where a nuanced understanding of the research is imperative. CMS 100 is designed to minimize this barrier by designing the correct structure, dialogue and workflow to deliver the concepts accurately and in the right situations. Thus, CMS 100 systematically delivers an optimal customer communication that is customized based on multiple factors and delivered in a consistent fashion.

The following paragraphs provide context on the myriad of research that can be deployed using CMS 100. The following discussion is not exhaustive, but rather, it represents the types of research that can be deployed accurately then scaled for mass use in customer interactions through CMS 100. Some specific examples are also given to deliver an understanding of how the concepts might be deployed in specific circumstances. The examples come from a loss mitigation deployment for mortgage services or financial services, though the scope of use of CMS 100 should not be limited solely to mortgage services or financial services.

### Authority Principle

People respond to those in control or seen as authorities. This effect can extend to any trappings of success or cues of control or position. Authority must be seen as legitimate and direct for it to be maximally effective.

### Visceral Heuristic

The idea that very emotive images will elicit a stronger response. This can backfire if clear instructions are not given to resolve the emotional arousal created by the approach.

### Liking Principle

If people like you more, they are more willing to work with you. This can be extended through verbal and nonverbal mimicry as well as indirect- (i.e., basking in reflected glory, cutting off reflected failure, etc.) and direct self-presentation (self-promotion, modesty, etc.). These efforts can backfire in a variety of very specific ways. For instance, if using modesty, it is effective but only to the extent that the audience knows one's achievements, otherwise, the self-presenter seems less competent.

### Social Proof

If you are unaware of how to act in a given scenario, you look to cues provided by those around you, especially when the situation has emotional implications. Framing the social proof scenario is very important to mitigate risk with the technique. Consider the example of a call center agent in a loss mitigation setting who is trying to establish empathy with a customer. The agent may say something like:

Mr./Ms. Borrower, I understand your concerns. I talk to hundreds of people every week who are in similar situations to yours . . .

The social proof provided by the mention of other customers who are also in default would actually make the customer less likely to respond to an effort at loss mitigation since it seems that everyone else is in a similar situation. However, social proof can be re-framed in a manner similar to the following example:

Mr./Ms. Borrower, I understand your concerns. This year alone our programs have helped over 77,000 homeowners in similar situations to yours to save their homes from foreclosure . . .

The later example uses social proof in the correct psychological context, arguing that the customer can join a group that is seeking help to resolve delinquency. In this example, a subtle shift in the presentation of the social proof technique places the impetus to action in the right direction (i.e., solving delinquency through action versus taking no action). Without a standardized communication method, it would be very easy for a user to get the framing of this technique incorrect, especially in a circumstance where the user has to respond to a number of other cognitive demands.

### Availability Heuristic

Judgments are often based on how easy it is to remember something versus using all available (or correct) data. This can apply to the vividness of information or ease with which information can be made salient. As an example of how communication can be enhanced through the proper use of combining techniques, consider the example from above:

Mr./Ms. Borrower, I understand your concerns. This year alone our programs have helped over 77,000 homeowners in similar situations to yours to save their homes from foreclosure . . .

Using availability to make the scale of 77,000 come to mind more easily, the example can be improved:

Mr./Ms. Borrower, I understand your concerns. This year alone our programs have helped over 77,000 homeowners in similar situations to yours to save their homes from foreclosure. That's equal to over a quarter of the entire population of Pittsburgh, Pa.

In-group bias:

When customers favor members of their group even at the expense of non-group members. This can be prompted through even minimal group paradigms wherein the customer's group membership is not directly sought and is incidental (e.g., feeling more camaraderie with someone because they like the same sports team as you).

### Scarcity Principle

Options which are less likely to be available due to time or resources are seen as having more value.

### Default Heuristic

Often when people are unsure how to act, they look to the default choice as the anchor and then adjust from it. This often leads to taking the status quo, or default option. This can be used in communication to direct someone to the optimal choice in a given set of alternatives.

### Anchor-and-adjustment Heuristic

Judgments are often based on the process of picking a mental reference point (an “anchor”) then adjusting from that reference. The problem is that we do not adjust adequately from the anchor, leading to inaccurate judgments.

### Momentum/trajectory Bias

When people feel they have made progress toward a goal then they will become more committed toward achieving the goal, even if the progress is subjective. Further, when people feel they are making little progress, they will be more likely to abandon the goal, even if their feelings of inertia are not objective.

### Peak-end Effect

People often judge an experience by its peak, or most intense level as well as its intensity at the end of the experience, without accounting for the average intensity level over the duration of the experience.

### Simulation Heuristic Description

This involves counter- or pre-factual mental simulations wherein our judgments can be swayed by thinking of how things might have (or may) turn out differently. Counterfactuals are amplified based on closeness to the actual event, ease of replication, perceived control or being a result of action versus inaction.

### Commitment Principle

If we make a either a public or private commitment to a particular course of action, we often feel bound to follow through on it due to perceived social rejection or cognitive dissonance. People will be more likely to follow a course of action if it causes more dissonance to break the commitment than to follow through with it.

### Reciprocity Principle

This is the idea that giving something to someone else (or taking an action on one's behalf) will prompt the person to return the favor in kind. The principle will work even in cases of asymmetric exchanges.

### Consistency Principle

To reduce cognitive dissonance, individuals behave in ways that are consistent with thoughts or beliefs as well as past behavior. This can lead to taking actions to maintain consistency primarily for the reason of maintaining consistency.

### Endowment Effect

When people perceive ownership over something, they will place a higher value on the object than it is objectively worth. Further, people will expect higher prices for the object when they perceive ownership than when not.

That' s-not-all Principle

This involves placing an incremental improvement to an offer before an initial response to the offer is given. The “added” portion of the offer is given more weight than if it were included as part of the original offer. Further, people will see the offer as being better than if all the aspects of the offer were included originally.

### Debiasing of Sunk-cost Heuristic

When we have put effort into something, we are often reluctant to pull out because of the loss that we will make, even if continued refusal to jump ship will lead to even more loss. The potential dissonance of accepting that we made a mistake acts to keep us in blind hope.

### Emotional Optimization

People often respond better to an appeal when the appeal diffuses emotional reactions in an optimized fashion. For example, consider a customer communication that is designed to offer a “cash-for-keys” program to borrowers who have been through foreclosure, but that are staying in their homes pending eviction. Such “cash-for-keys” programs offer borrowers money for relocation in assistance for moving out before foreclosure. This helps the borrower make the housing transition and it helps a loan servicer by allowing the property to be re-sold sooner and in better condition. However, borrowers can resist these types of programs because of the emotion associated with leaving their homes. Not all borrowers respond to the offers the same way, though. Using CMS 100, psychological theory in diffusing emotions could be used to maximize the effectiveness of helping borrowers through these programs. CMS 100 gives the ability for a call center user to completely change all scripting to accommodate a borrower's emotional patterns with the click of one button, leading to an emotionally-optimized message.

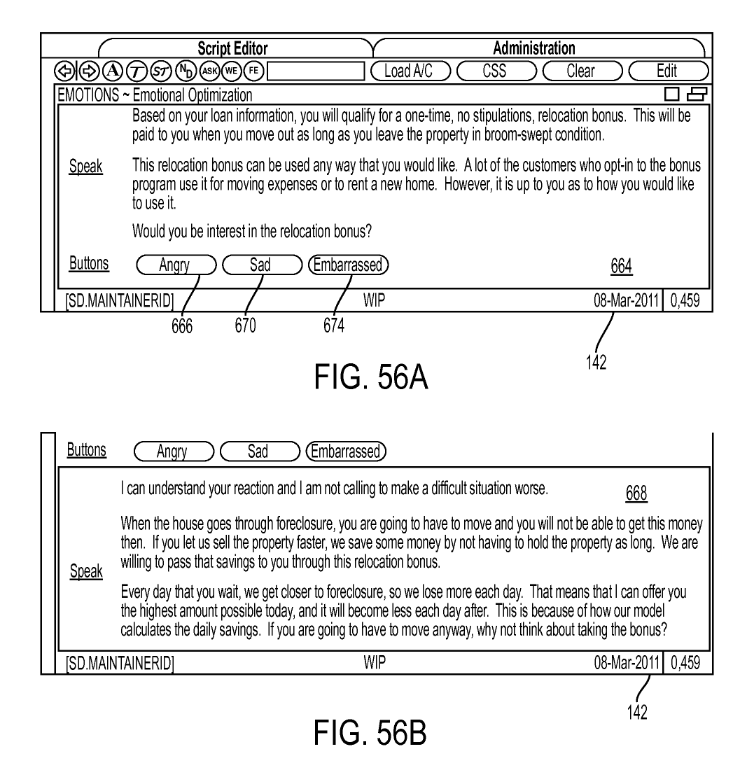

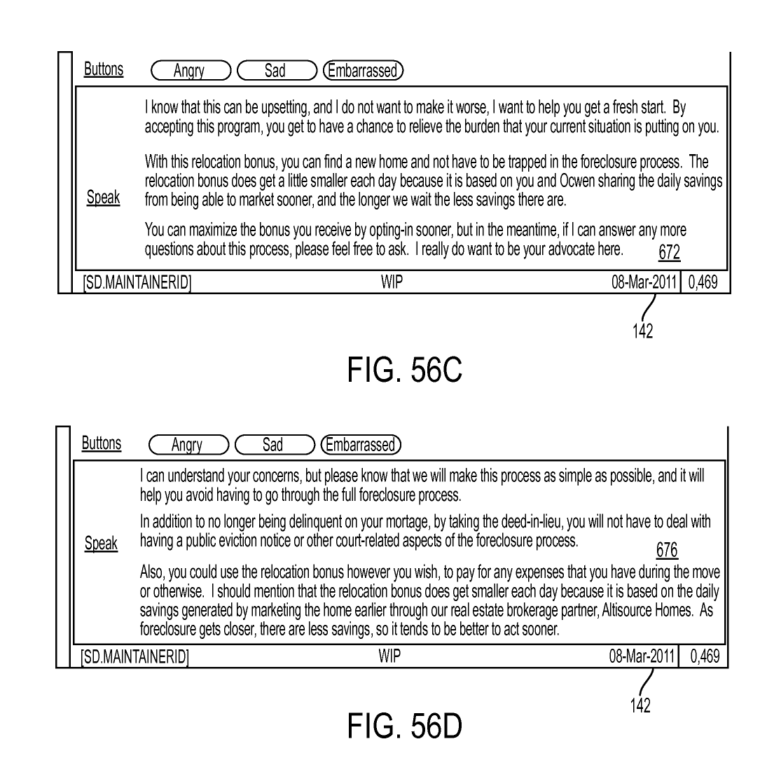

Referring to FIG. 56A, a general script 664 is shown that is written for a “cash-for-keys” offer and is delivered using CMS 100. If the borrower is responding to the user in an angry fashion, the user can select an “angry” button 666 that changes the offer to be more direct and to the point in order to minimize frustration and “platitudes” which can add to the customer's anger. Thus, referring to FIG. 56B, a conversation script 668 is generated to address and diffuse the customer's emotion. If, instead, the customer exhibits sadness or wistfulness over his/her current status, the user can select a “sad” button 670 (FIG. 56A). Referring to FIG. 56C, as a result of the user's actions, a conversation script 672 is generated to highlight removing the burden of the situation and becomes more supportive and accepting (the type of “platitudes” that may make the angrier borrower more emotionally charged). In the alternative, if the customer seems embarrassed, the user may select an “embarrassed” button 674. Referring to FIG. 56D, a conversation script 676 is immediately generated to diffuse the customer's embarrassment by touting the relative anonymity of the transaction versus eviction or foreclosure.

In some embodiments, customer interface 102 may be a telephone system that may include an auto-dialer or IVR system. In some of these embodiments, the customer communication may be monitored using a voice recognition system. The voice recognition system may be configured to detect the customer's physiological state or pattern of traits, including but not limited to emotions, by determining a baseline physiological state or pattern of traits of the customer in the first few seconds of the call and then comparing the speech pattern of the customer throughout the rest of the call to detect changes in the customer's physiological state or pattern of traits. Additionally, the call can be electronically monitored to detect keywords that indicate the possible state of the customer's emotions. Based on the detected emotion, CMS 100 may be configured to alert the user to the customer's potential emotion so that the user may select the proper emotion to modify the script. Furthermore, automated emotion detection systems may monitor one or more of the customer's pitch, tone, tempo and inflection to detect the current state of the customer's emotion in order to affect changes in the script. In other embodiments, CMS system 100 may be configured to automatically detect the customer's emotion and automatically adjust the script accordingly without the user's knowledge. It should be understood that other automated systems may be employed that detect potential changes in the customer's emotion throughout the call and that either alert the user to the change in the customer's emotion so that the agent can select a corresponding emotion button to change the script or that automatically cause changes in the script based on the customer's detected physiological state or pattern of traits. These changes may occur once during the call or each time the system detects changes in the customer's physiological state or pattern of traits. In this way, the scripted conversation may change in real-time as the communication progresses. As a result, the scripted conversation is optimized using the above described behavioral techniques to influence the customer.

The techniques and concepts described herein, and their use in CMS 100 is not limited to a particular domain such as mortgage or financial services. Nor is CMS 100 limited for use in customer contact via a call center. Thus, one skilled in the art should understand that CMS 100 may be configured to communicate with a customer through a web interface, over a handheld device or by any other communication medium that allows a user to communicate with a customer. The proposed system can apply to any domain wherein (1) multiple data sources are accessed in a single transaction, (2) specific directions are required to guide someone through transformation or manipulation of the data, (3) effective communication needs to be established according to a multifaceted, logic-based schema, and (4) communication needs to be delivered consistently and/or in a scalable manner even though the steps or dialogues are highly configurable based on inputs or other rules.

In another preferred embodiment, CMS 100 includes a dialer as customer interface 102 and at least one business parent system 106 that uses customer analytics to analyze customer information. Based on the customer analytics, scripting system 104 and customer interface 102 can be used to determine a desired outcome and scripting system 104 can determine an optimized predetermined scripted conversation to achieve the desired result. As the predetermined scripted conversation progresses and additional customer information is received and processed by business system 106, the desired outcome and method of achieving the desired outcome can be changed in real-time to reflect the updated customer analytics.

For example, a cable company may wish to offer a cable package that includes a children's channel to a plurality of customers that is determined to have children based on customer demographic information used by the analytics engine in business system 106. Scripting system 104 prepares a predetermined scripted conversation using principles of behavioral influence to optimize the scripted conversation to achieve the result of having the plurality of customers purchase the cable package. As the customer contact progresses, the user may receive customer information, such as the customer does not have children. Thus, the acquired information is passed in real-time to business system 106 to be analyzed by the customer analytics engine. Updated customer analytic information is passed back to scripting system 104 in real-time so as to adjust at least one of the (1) the product or service being offered, (2) the attributes of the product or service being offered such as price, terms, etc. and (3) the behavioral influence used in the delivery of the customer conversation. For example, the cable package may be adjusted in real-time to remove the children's channel and include channels of interest to the customer. The scripting system receives the changes and reflects the change and/or the change in behavioral sciences-based principles used in the delivery of the customer conversation to optimize obtaining the desired outcome from the customer communication.

If business system 106 receives information that the customer does not watch TV, the business system analytics engine may determine in real-time that the offer should be changed from a cable package to an internet package, and based on the customer demographics may offer a package that fits the customer's income bracket. Thus, the new desired result, to sign up a new internet subscriber, is passed back to scripting system 104 in real-time and the predetermined scripted conversation changes to reflect the new desired outcome. Furthermore, the behavioral sciences-based principles applied to the original scripted conversation may also change to optimize the desired outcome of obtaining a new subscriber. Throughout the customer communication, information received by scripting system 104 is passed to business system 106 so that the analytics engine can adjust the desired outcome and/or the method in which the desired outcome is achieved to optimize the chance of obtaining the desired outcome. Moreover, scripting system 104 will also change the behavioral sciences-based principles to optimize the scripted conversation to achieve the desired outcome.

In other preferred embodiments, the scripted conversation is delivered using an automated Interactive Voice Response (IVR) system. In still other embodiments, customer interface 102 is an interactive internet webpage that allows the customer to receive scripted conversation and enter information in response to the scripted conversation.

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit of the claims.

We claim:

1. A customer communication system comprising:
a. a customer interface;
b. at least one business system; and
c. a scripting system operatively coupled to said customer interface and said at least one business system, said scripting system comprising:
iv. at least one processor, and
v. at least one memory,
wherein said at least one processor is configured to
i. communicate with said customer interface,
ii. communicate with said at least one business system in real-time using a data format containing a unique identifier and a token value that can be associated with a data value, and
iii. provide a scripted conversation to be delivered to a customer, where
the scripted conversation is predetermined based on one of information contained in a customer account, information provided by the customer and analytics; and
the predetermined scripted conversation changes in real-time based on psychological factors of the customer, detected during the customer communication.

2. The customer communication system of claim 1, wherein the customer's detected psychological factors are automatically detected and the predetermined scripted conversation is automatically changed based on the customer's detected psychological factors.

3. The customer communication system of claim 1, wherein a user of the customer communication system detects the psychological factors of a customer and selects an option corresponding to the customer's psychological factors to cause a real-time change in the predetermined scripted conversation.

4. The customer communication system of claim 1, wherein the psychological factors are based on the customer's emotional state.

5. The customer communication system of claim 1, wherein the predetermined scripted conversation is written based on behavioral sciences-based principles.

6. The customer communication system of claim 5, wherein the predetermined scripted conversation is changed to reflect behavioral sciences-based principles that address the detected customer psychological factors.

7. The customer communication system of claim 5, wherein the behavioral sciences-based principles comprise at least one of an authority principle, a visceral heuristic, a liking principle, a social proof, an availability heuristic, an in-group bias, a scarcity principle, a default heuristic, an anchor-and-adjustment heuristic, a momentum/trajectory bias, a peak-end effect, a simulation heuristic description, a commitment principle, a reciprocity principle, a consistency principle, an endowment effect, a that's-not-all principle and a debiasing of sunk-cost heuristic.

8. A scripting system comprising:
a. at least one processor, and
b. at least one memory,
wherein
i. the scripting system is configured to communicate with a plurality of disparate business system databases by making a read request that includes a header having a unique identifier and a token, to which at least one of the plurality of disparate business systems respond by returning a value associated with the token,
ii. the at least one processor is configured to
facilitate a predetermined scripted conversation with a customer based on information contained in the at least one of the plurality of business systems, and
change the predetermined scripted conversation in real-time throughout the customer communication based on information received from the customer to change at least one of the desired outcome, the method in which to achieve the desired outcome and behavioral sciences-based principles that affect the wording of the script that optimize achievement of the desired outcome.

9. The scripting system of claim 8, wherein information received from the customer is written back, via the at least one processor, to at least one of the plurality of disparate business systems.

10. The scripting system of claim 8, wherein the processor is configured to change the predetermined scripted conversation in real-time based on psychological factors of the customer detected during the customer communication.

11. The scripting system of claim 10, wherein the customer's psychological factors are automatically detected by at least one of the customer's speech pattern, voice tone, voice pitch level, voice tempo, inflection and keywords.

12. The scripting system of claim 10, wherein the customer's psychological factors are automatically detected by at least one of the customer's speech pattern, voice tone, voice pitch level, voice tempo, inflection and keywords and the processor is configured to notify a user of the scripting system of the customer's likely psychological factors so that the user may manually select an option that automatically changes the predetermined scripted conversation.

13. The customer communication system of claim 8, wherein the predetermined scripted conversation is written based on behavioral sciences-based principles.

14. The customer communication system of claim 8, wherein the wherein the behavioral sciences-based principles comprise at least one of an authority principle, a visceral heuristic, a liking principle, a social proof, an availability heuristic, an in-group bias, a scarcity principle, a default heuristic, an anchor-and-adjustment heuristic, a momentum/trajectory bias, a peak-end effect, a simulation heuristic description, a commitment principle, a reciprocity principle, a consistency principle, an endowment effect, a that's-not-all principle and a debiasing of sunk-cost heuristic.

15. The scripting system of claim 8, wherein the processor is further configured to allow an administrator to reconfigure the system to provide new and modified functionality without having to recode and recompile the system.

16. The scripting system of claim 8, wherein the read request uses extensible markup language.

17. A scripting system comprising:
a. at least one processor, and
b. at least one memory,
wherein
i. the scripting system is configured to communicate with at least one disparate business system in real-time,
ii. the at least one processor is configured to
a) receive a desired outcome from the at least one disparate business system;
b) facilitate a predetermined scripted conversation with a customer to achieve the desired outcome,
c) receive information from the customer so at least one of the desired outcomes and the method in which the desired outcome is achieved is changed in real-time;
d) change the predetermined scripted conversation in real-time to reflect the change in the at least one of desired outcomes and the method in which the desired outcome is achieved, and behavioral sciences-based principles that affect the wording of the script to optimize achievement of the desired outcome.

18. The scripting system of claim 17, wherein the at least one business system receives the received customer information and makes the decision to change the at least one of the desired outcomes and the method in which the desired outcome is achieved.

19. The scripting system of claim 17, wherein the method in which the desired outcome is achieved comprises at least one of a price, a purchase term, a product feature and a service feature.

20. The scripting system of claim 17, wherein the change of the at least one of the desired outcome and the method in which the desired outcome is achieved is made by the scripting system.

21. The scripting system of claim 17, wherein the changes to the script based on behavioral sciences-based principles is changed in real-time based on a perceived psychological state or trait of the customer detected during the customer communication.

22. The scripting system of claim 21, wherein the perceived psychological state or trait of the customer is either detected automatically by the scripting system or detected manually by a user of the scripting system.
